(19) United States
(12) Patent Application Publication
(10) Pub. No.: US 2002/0117612 A1
(43) Pub. Date: Aug. 29, 2002

(54) Method for laser cooling of atoms and apparatus therefor as well as coherent light source used for laser cooling of atoms

(76) Inventors: Hiroshi Kumagai, Wako-Shi (JP); Katsumi Midorikawa, Wako-Shi (JP)

Correspondence Address: BIRCH STEWART KOLASCH & BIRCH, PO BOX 747, FALLS CHURCH, VA, 22040-0747, US

(21) Appl. No.: 10/058,086

(22) Filed: Jan. 29, 2002

(30) Foreign Application Priority Data
Jan. 29, 2001 (JP) 2001-20243
Jan. 21, 2002 (JP) 2002-11558

(51) Int. Cl. H01S 1/00

(52) U.S. Cl. 250/251

(57) ABSTRACT

A method for laser cooling of atoms for laser-cooling atoms each involving a plurality of magnetic subsidiary levels as its cooling lower level being in a ground state in energy level wherein each coherent light of a predetermined wavelength containing a plurality of different polarized light is emitted sequentially to the atoms in response to the plurality of magnetic subsidiary levels being the cooling lower level in the ground level in an atom, which is an object to be laser-cooled, while keeping a predetermined time interval, whereby it becomes possible to laser-cool a variety of atoms including semiconductor atoms such as silicon and germanium.

### BACKGROUND OF THE INVENTION

1. Field of the Invention

The present invention relates to a method for laser cooling of atoms and an apparatus therefor as well as a coherent light source used for laser cooling of atoms, and more particularly to a method for laser cooling of atoms used suitably in case of laser cooling of a variety of atoms such as silicon atoms, and germanium atoms each having a plurality of magnetic subsidiary levels as its cooling lower level in energy level, and an apparatus therefor as well as a coherent light source used for laser cooling of such atoms.

2. Description of the Related Art

In recent years, developments in field of application for laser cooling of atoms exhibit quantum leap with starting from substantiation of Bose-Einstein condensation and breakthroughs of atom laser, nonlinear atom optics and the like.

In such laser cooling field of application, if it becomes possible to realize laser cooling of semiconductor atoms such as silicon, and germanium in stead of alkaline metal atoms and the like, which have been heretofore an object of laser cooling, novel developments can be expected from engineering point of view, and hence, expansion in possibilities of application is inestimable.

In these circumstances, there has been a strong need for provision of a technology for laser-cooling a variety of atoms including semiconductor atoms such as silicon and germanium.

### OBJECTS AND SUMMARY OF THE INVENTION

The present invention has been made in view of needs involved in the prior art as described above.

An object of the present invention is to provide a method for laser cooling of atoms by which it becomes possible to laser-cool a variety of atoms including semiconductor atoms such as silicon and germanium, and an apparatus therefor as well as a coherent light source used in the apparatus and such laser cooling of these atoms.

In order to achieve the above-described objects, a method for laser cooling of atoms and an apparatus therefor as well as a coherent light source used for laser cooling of atoms are implemented in accordance with a manner as described hereinafter.

Laser cooling of atoms means herein a cooling method wherein the atoms collide against (are scattered with) laser beam to repeat absorption and spontaneous emission of light, whereby kinetic energy of the atoms is released into such spontaneous emission of light, whereby the atoms are cooled.

Such a process for laser cooling of atoms can be classified into a stage wherein atoms are sufficiently decelerated, and a stage wherein the atoms decelerated sufficiently are cooled. In such deceleration of atoms and cooling of atoms, a scattering force functions as shown in FIG. 1.

In the following, “deceleration of atoms due to scattering force” and “cooling of atoms due to scattering force” will be described in detail hereinafter.

First, cooling of atoms due to scattering force will be described. The cooling of atoms due to scattering force means so-called “Doppler cooling”. Namely, Doppler shift acts most effectively with respect to cooling of atoms, which have been decelerated to around several times wider width than natural width.

In order to effect cooling of atoms by means of spontaneous emission, it is required that an average energy of photons emitted is higher than that of photons absorbed. Namely, Doppler cooling means to realize such a situation wherein an average energy of emitted photons is higher than that of absorbed photons. A particularly effective negative detuning amount is around natural width (half width at half maximum) of resonance.

Incidentally, since natural width (half width at half maximum) of silicon is around 28 MHz, laser having a linewidth of the same degree as or lower degree than that of the natural width, i.e., around 28 MHz is required for Doppler cooling. Furthermore, such laser takes about 130 microseconds until it reaches 220 μ Kelvin corresponding to Doppler cooling temperature, so that it is required to use a continuous wave (CW) light source.

It is to be noted that natural width (half width at half maximum) of silicon, Doppler cooling temperature, and time (stop time) required for reaching 220 μ Kelvin corresponding to the Doppler cooling temperature are determined by the mathematical expressions shown in FIG. 2.

Next, deceleration of atoms due to scattering force will be described herein. In this case, a melting point of silicon is 1414° C., while a melting point of germanium is 958.5° C., melting points of both the materials being high melting points, respectively.

A velocity of silicon atom, which ran off from the surface by means of electron-beam evaporation, exhibits Boltzmann distribution centering on about 1000 m/s (meter per second). A half-value width thereof is wide, i.e., about 1500 m/s or more, so that it is about 6 GHz (gigahertz) in a resonance frequency region.

Namely, Doppler broadening (Doppler width) due to velocity broadening is about 6 GHz at melting temperature.

Accordingly, when a frequency of a single frequency coherent light source is changed with a lapse of time to effect chirped cooling in the case where the single frequency coherent light source is used, it becomes possible to decelerate atoms.

On one hand, it may be arranged to use picosecond laser for decelerating atoms. Namely, in pulses of Fourier transform-limit, 100 picoseconds can involve a frequency zone of 10 GHz. In other words, when the picosecond laser is used, atomic beams, which are in Doppler velocity broadening, can be decelerated at the same time.

Doppler width is determined by the numerical expression shown in FIG. 3.

The reason why laser cooling of silicon atoms is difficult resides not only in that a cooling wavelength is short, but also in that energy level in a ground state, i.e., its cooling lower level being in a ground level involves a plurality of magnetic subsidiary levels, and specifically, three magnetic subsidiary levels.

More specifically, there are three magnetic subsidiary levels as its cooling lower level being a ground level in silicon atom, so that a magnetooptic trap cannot be prepared as in case of alkaline metal atom. This is a major cause of difficulty in laser cooling of silicon atoms.

Referring to FIGS. 4(a) and 4(b), a detailed explanation will be further continued. In silicon atom, a magnetic quantum number m is degenerated in three magnetic subsidiary levels “m =−1”, “m=0”, and “m=+1” in energy level in a ground state, i.e., its cooling lower level (3s²p^{2 3}p₁, J=1) being the ground level.

In order to laser-cool silicon atoms, it is required that laser beams are emitted to the silicon atoms to excite them, whereby their energy level is elevated from their cooling lower level in their ground state to their cooling upper level (3s3P²4s ³Po, J=0) being their excitation level.

As a result, the silicon atoms are excited by means of emission of laser beams, whereby they are elevated to the cooling upper level. However, such silicon atoms excited from the cooling lower level to the cooling upper level return again to the cooling lower level after expiring spontaneous emission lifetime.

In this case, silicon atoms in the cooling upper level return equivalently to three magnetic subsidiary levels “m=−1”, “m =0”, and “m+1” with one third each of them in the case where the silicon atoms return from the cooling upper level to the cooling lower level (a solution is obtained from the simultaneous differential equations shown in FIG. 4(b).).

On one hand, silicon atoms in the magnetic subsidiary level of “m=−1” being its cooling lower level in a ground state are excited to its cooling upper level when laser beams of right-handed polarized light (σ+) were emitted to such silicon atoms, silicon atoms in the magnetic subsidiary level of “m=0” being its cooling lower level in a ground state are excited to its cooling upper level when laser beams of linearly polarized light (π) were emitted to such silicon atoms, and silicon atoms in the magnetic subsidiary level of “m=+1” being its cooling lower level in a ground state are excited to its cooling upper level when laser beams of left-handed polarized light (σ−) were emitted to such silicon atoms.

Accordingly, when it is intended to implement laser cooling of silicon atoms by emitting, for example, linearly polarized light, only the silicon atoms in the magnetic subsidiary level “m=0” among cooling lower levels being in a ground state are excited to its cooling upper level. Then, the silicon atoms thus excited to the cooling upper level return to the magnetic subsidiary levels after expiring spontaneous emission lifetime wherein only one third of the silicon atoms return to the magnetic subsidiary level of “m=0” among cooling lower levels being in a ground state. Hence, silicon atoms, which are to be excited from their cooling lower level being in their ground state to their cooling upper level, decrease gradually, so that a magneto-optic trap as in a case of alkaline metal atoms could not have been prepared.

Likewise, since there is a plurality of magnetic subsidiary levels in also germanium atom as its cooling lower level, laser cooling of germanium atoms was difficult.

For the sake of overcoming such difficulty as described above, a method for laser cooling of atoms according to the present invention is arranged in such that in case of laser-cooling the atoms each involving a plurality of magnetic subsidiary levels as its cooling lower level, each laser beam having a plurality of polarized light in response to the plurality of magnetic subsidiary levels being its cooling lower level in a ground state is emitted sequentially to the atoms with a predetermined time interval. In other words, the method is to control time-varyingly polarized light in laser beam by emitting repeatedly such laser beam involving different polarized light in order in each predetermined period of time.

In the case where laser beam involving different polarized light is emitted repeatedly in order in each predetermined period of time, it is arranged in such that photons are struck on an atom successively with a time interval corresponding to twice longer than spontaneous emission lifetime of the atom, i.e., which is a time required for absorption—emission of one photon, whereby an atom being in its cooling lower level in a ground state can be excited efficiently to its cooling upper level.

Accordingly, a method for laser cooling of atoms for laser-cooling atoms each involving a plurality of magnetic subsidiary levels as its cooling lower level being in a ground state in energy level of the present invention comprises emitting sequentially each coherent light of a predetermined wavelength containing a plurality of different polarized light to the atoms in response to the plurality of magnetic subsidiary levels being the cooling lower level in the ground state in an atom, which is an object to be laser-cooled, while keeping a predetermined time interval.

Furthermore, the method for laser cooling of atoms described in the above invention wherein the predetermined time interval is that substantially twice longer than spontaneous emission lifetime of the atom corresponding to a time required for absorption—emission of one photon.

Moreover, an apparatus for laser cooling of atoms for laser-cooling atoms each involving a plurality of magnetic subsidiary levels as its cooling lower level being in a ground state in energy level according to the present invention comprises a coherent light source for producing a coherent light having a predetermined wavelength; a polarized light control means for controlling polarized light of the coherent light output from the coherent light source to emit the coherent light of different polarized light to the atom with a predetermined time interval; and the polarized light of the coherent light emitted from the polarized light control means corresponds respectively to the plurality of different polarized light in response to the plurality of magnetic subsidiary levels being the cooling lower level in the ground state of an atom, which is an object to be laser-cooled.

Sill further, an apparatus for laser cooling of atoms for laser-cooling atoms each involving a plurality of magnetic subsidiary levels as its cooling lower level being in a ground state in energy level according to the present invention comprises a plurality of coherent light sources outputting respectively a coherent light of a predetermined wavelength involving respectively a plurality of different polarized light in response to the plurality of magnetic subsidiary levels being the cooling lower level in the ground state of an atom, which is an object to be cooled; each coherent light of the predetermined wavelength containing the plurality of different polarized light output from the plurality of coherent light sources being sequentially emitted to the atom while keeping a predetermined time interval; and the polarized light of the coherent light emitted from the plurality of coherent light sources corresponding respectively to the plurality of different polarized light in response to the plurality of magnetic subsidiary levels being the cooling lower level in the ground state of the atom, which is the object to be laser-cooled.

The apparatus for laser cooling of atoms described in the above invention wherein at least one of the plurality of coherent light sources is that outputs selectively coherent light involving two different polarized light.

Further, the apparatus for laser cooling of atoms described in the above invention wherein the predetermined time interval is that substantially twice longer than spontaneous emission lifetime of the atom corresponding to a time required for absorption—emission of one photon.

In addition, a coherent light source used for laser cooling of atoms according to the present invention comprises a mode-locked (lock) picosecond laser for outputting coherent light of a predetermined wavelength; a wavelength conversion element for converting a wavelength of the coherent light of the predetermined wavelength output from the mode-locked (lock) picosecond laser; a wavelength dispersion element for selecting coherent light of a desired wavelength from the coherent light, which has been subjected to wavelength conversion by means of the wavelength conversion element, to output the coherent light selected; and a feedback circuit for measuring a wavelength of the coherent light output from the wavelength dispersion element to output a signal to the mode-locked (lock) picosecond laser in such that the mode-locked (lock) picosecond laser outputs coherent light of a predetermined wavelength on the basis of the measured result.

Yet further, an apparatus for laser cooling of atoms for laser-cooling atoms each involving a plurality of magnetic subsidiary levels as its cooling lower level being in a ground state in energy level according to the present invention comprises a coherent light source producing coherent light of predetermined wavelength; a polarized light control means including a half-wavelength plate and an acousto-optic device, and controlling polarized light obtained from the coherent light output from the coherent light source by means of the half-wavelength plate to emit coherent light involving different polarized light to the atoms with a predetermined time interval; and chirped cooling being effected by changing time-varyingly a frequency by the use of the acousto-optic device to decelerate the atoms as well as to separate time-varyingly the polarized light obtained by means of the half-wavelength plate with the use of the acousto-optic device, besides to optimize the frequency thereby cooling the atoms by means of scattering force.

Furthermore, a coherent light source used for laser cooling of atoms according to the present invention comprises a first laser beam producing system for producing laser beam of a first wavelength; and a second laser beam producing system for producing laser beam of a second wavelength as well as for introducing the laser beam of the first wavelength produced in the first laser beam producing system there into to produce laser beam of a third wavelength as a result of sum frequency mixing of the laser beam of the first wavelength and the laser beam of the second wavelength.

Moreover, an apparatus for laser cooling of atoms for laser-cooling atoms each involving a plurality of magnetic subsidiary levels as its cooling lower level being in a ground state in energy level according to the present invention comprises a coherent light source including a first laser beam producing system for producing laser beam of a first wavelength, and a second laser beam producing system for producing laser beam of a second wavelength as well as for introducing the laser beam of the first wavelength produced in the first laser beam producing system thereinto to produce laser beam of a third wavelength as a result of sum frequency mixing of the laser beam of the first wavelength and the laser beam of the second wavelength; a polarized light control means including a half-wavelength plate and an acousto-optic device, and controlling polarized light obtained from the coherent light output from the coherent light source by means of the half-wavelength plate to emit coherent light involving different polarized light to the atoms with a predetermined time interval; and chirped cooling being effected by changing time-varyingly a frequency by the use of the acousto-optic device to decelerate the atoms as well as to separate time-varyingly the polarized light obtained by means of the half-wavelength plate with the use of the acousto-optic device, besides to optimize the frequency thereby cooling the atoms by means of scattering force.

### BRIEF DESCRIPTION OF THE DRAWING

The present invention will become more fully understood from the detailed description given hereinafter and the accompanying drawings which are given by way of illustration only, and thus are not limitative of the present invention, and wherein:

FIG. 1 is a view for explaining a force (scattering force) acts upon a neutral atom;

FIG. 2 is a diagram showing numerical expressions for determining natural width (half width at half maximum) of silicon, Doppler cooling temperature, and a time required for reaching 220 μ Kelvin being Doppler cooling temperature (stop time);

FIG. 3 is a diagram showing a numerical expression for determining Doppler width;

FIGS. 4(a), 4(b), and 4(c) are explanatory views wherein FIG. 4(a) shows energy levels, FIG. 4(b) shows simultaneous differential equations for determining the number of silicon atoms existing in respective energy levels, and FIG. 4(c) is a timing chart indicating a timing for emitting each coherent light of respective types of polarized light;

FIG. 5 is an explanatory block diagram for a conceptual constitution showing an example of a preferred embodiment of an apparatus for laser cooling of atoms according to the present invention;

FIGS. 6(a), 6(b), and 6(c) are explanatory diagrams each showing a condition of changes in a phase of laser beams with birefringent crystal wherein FIG. 6(a) shows a condition in which left-handed polarized light (σ−) appears, when a phase deviates between o-axis and e-axis by −π/2, FIG. 6(b) shows a condition in which linearly polarized light appears, when there is no deviation of a phase between the o-axis and the e-axis, and FIG. 6(c) shows a condition in which right-handed polarized light (σ+) appears, when a phase deviates between the o-axis and the e-axis by π/2;

FIG. 7 is an explanatory diagram showing such result that a time required for absorption - emission of one photon is two times longer than spontaneous emission lifetime (τ);

FIGS. 8(a) and 8(b) are explanatory views each showing a case of laser-cooling atoms by the use of three coherent light source devices as first through third coherent light sources wherein FIG. 8(a) is a conceptual explanatory diagram showing a constitution of an example of the preferred embodiment of an apparatus for laser cooling of atoms according to the present invention, and FIG. 8(b) is a timing chart indicating a timing for emitting each coherent light of three types of polarized light;

FIGS. 9(a) and 9(b) are explanatory views each showing a case of laser-cooling atoms by the use of two coherent light source devices as first and second coherent light sources wherein FIG. 9(a) is a conceptual explanatory diagram showing a constitution of an example of the preferred embodiment of an apparatus for laser cooling of atoms according to the present invention, and FIG. 9(b) is a timing chart indicating a timing for emitting each coherent light of two types of polarized light;

FIG. 10 is a constitutional explanatory diagram showing an example of a preferred embodiment of a coherent light source used for laser cooling of atoms, and more particularly an explanatory diagram showing a constitution of a coherent light source used for laser cooling of atoms as a light source for decelerating silicon atoms by means of scattering force;

FIG. 11 is a constitutional explanatory diagram showing an example of another preferred embodiment of a coherent light source used for laser cooling of atoms, and more particularly an explanatory diagram showing a constitution of a coherent light source used for laser cooling of atoms as a light source for decelerating silicon atoms by means of scattering force;

FIG. 12 is a constitutional explanatory diagram showing an example of a preferred embodiment of a laser cooling apparatus according to the present invention wherein one of the picosecond coherent light sources each used for deceleration of silicon shown in FIG. 10 (a picosecond coherent light source used for deceleration of silicon to which a function for controlling polarized light has been added) is used as a coherent light source used for laser cooling of atoms;

FIG. 13 is a constitutional explanatory diagram showing an example of the preferred embodiment of a laser cooling apparatus according to the present invention wherein one of the picosecond coherent light sources each used for deceleration of silicon shown in FIG. 11 (a picosecond coherent light source used for deceleration of silicon to which a function for controlling polarized light has been added) is used as a coherent light source used for laser cooling of atoms;

FIG. 14 is a constitutional explanatory diagram showing an example of the preferred embodiment of a laser cooling apparatus wherein one CW laser of 252.4 nm wavelength (a CW coherent light source used for deceleration/cooling of silicon to which a function for controlling polarized light has been added) is used as a coherent light source used for cooling atoms;

FIG. 15 is a schematic explanatory diagram showing a constitution of a coherent light source, which can be used as the CW laser for silicon of 252.4 nm wavelength designated by reference numeral 121 in FIG. 14;

FIG. 16 is a graphical representation indicating input-output characteristics in second harmonic wave generation of the coherent light source shown in FIG. 15 wherein input-output characteristics of output light having 373 nm wavelength with respect to input light having 746 nm wavelength are indicated;

FIG. 17 is a graphical representation indicating input-output characteristics in sum-frequency generation in 252 nm wavelength of the coherent light source shown in FIG. 15 wherein input-output characteristics of output light having 252 nm wavelength with respect to input light having 780 nm wavelength in the case where input light having 373 nm wavelength is made to be constant at 480 mW are indicated;

FIG. 18 is a constitutional explanatory diagram showing an example of a further preferred embodiment of a coherent light source used for laser cooling of atoms, and more particularly an explanatory diagram showing a constitution of a coherent light source used for laser cooling of atoms as a light source for decelerating germanium atoms by means of scattering force;

FIG. 19 is a constitutional explanatory diagram showing an example of still another preferred embodiment of a coherent light source used for laser cooling of atoms, and more particularly an explanatory diagram showing a constitution of a coherent light source used for laser cooling of atoms as a light source for decelerating germanium atoms by means of scattering force;

FIG. 20 is a constitutional explanatory diagram showing an example of a further preferred embodiment of a laser cooling apparatus according to the present invention wherein one of the picosecond coherent light sources each used for deceleration of germanium shown in FIG. 18 (a picosecond coherent light source used for deceleration of germanium to which a function for controlling polarized light has been added) is used as a coherent light source used for laser cooling of atoms;

FIG. 21 is a constitutional explanatory diagram showing an example of the further preferred embodiment of a laser cooling apparatus according to the present invention wherein one of the picosecond coherent light sources each used for deceleration of germanium shown in FIG. 19 (a picosecond coherent light source used for deceleration of germanium to which a function for controlling polarized light has been added) is used as a coherent light source used for laser cooling of atoms; and

FIG. 22 is a constitutional explanatory diagram showing an example of the further preferred embodiment of a laser cooling apparatus wherein one CW laser of 271 nm wavelength (a CW coherent light source used for deceleration/cooling of germanium to which a function for controlling polarized light has been added) is used as a coherent light source used for cooling atoms.

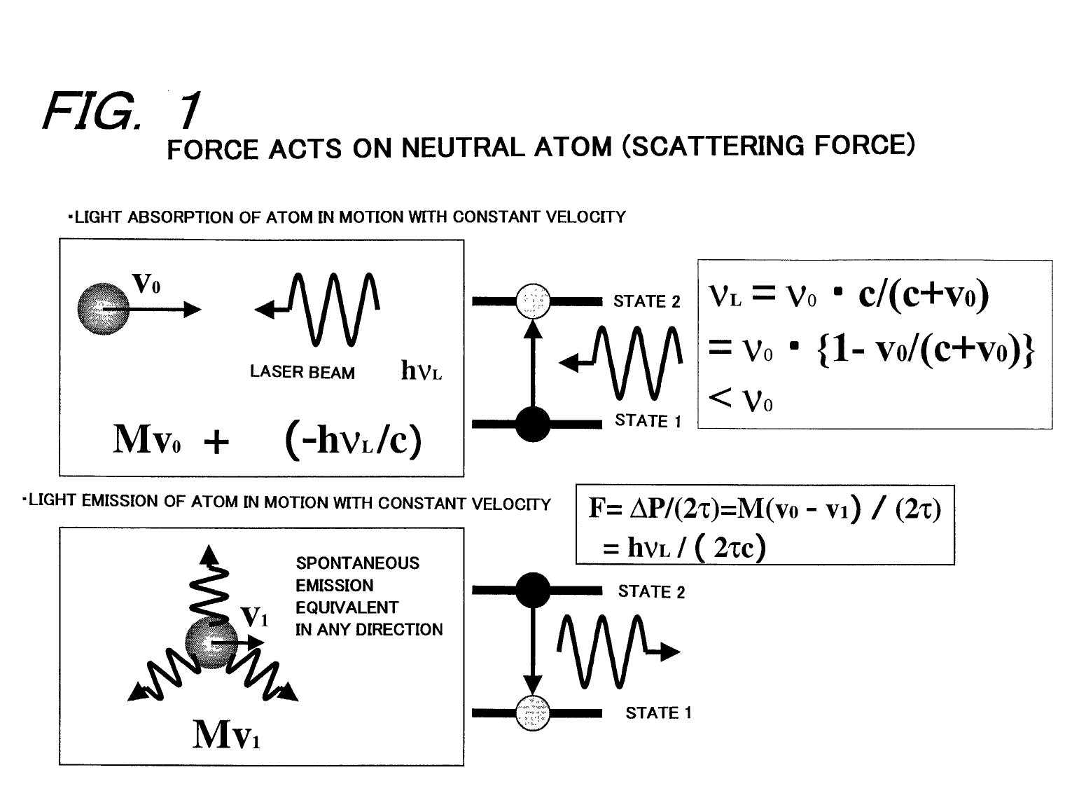

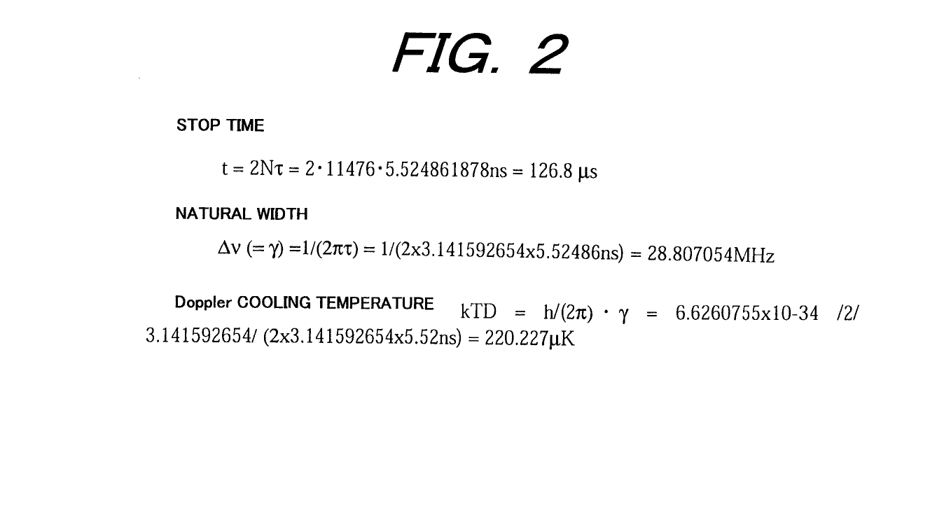

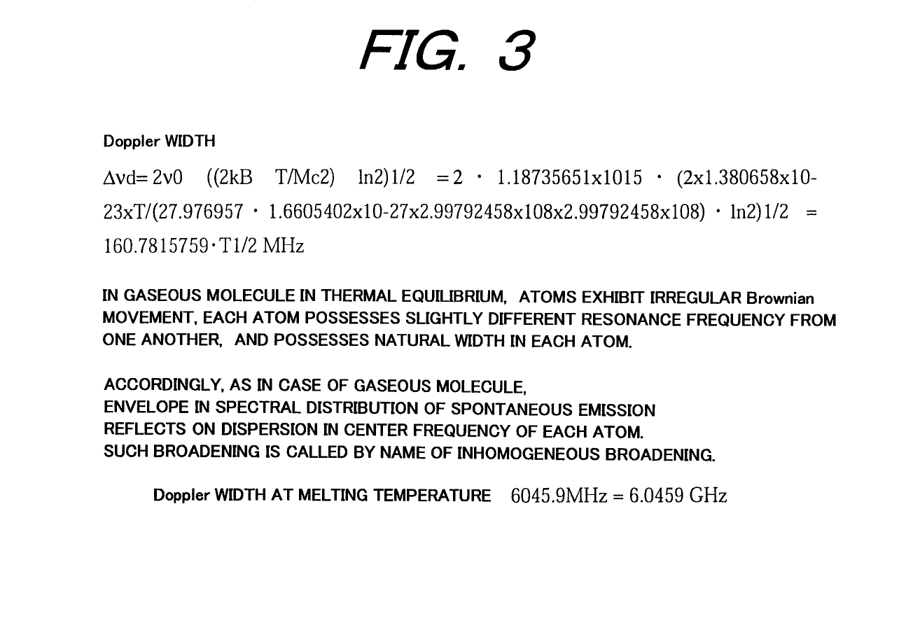

### DETAILED DESCRIPTION OF THE PREFERRED EMBODIMENTS

In the following, an example of each preferred embodiment of a method for laser cooling of atoms and an apparatus therefor according to the present invention will be described in detail by referring to the accompanying drawings.

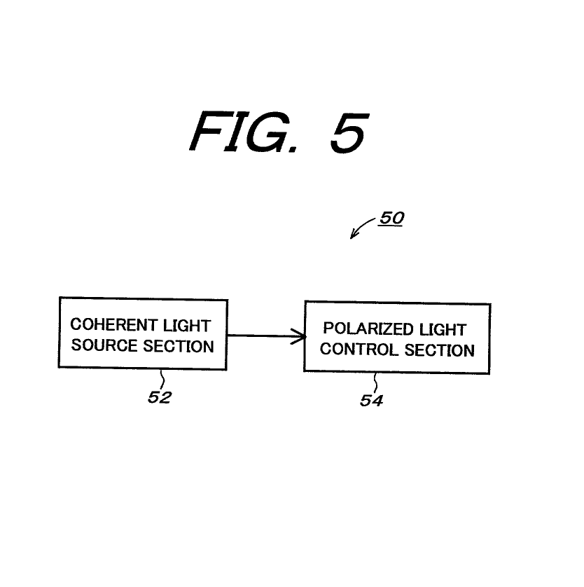

FIG. 5 is an explanatory block diagram for a conceptual constitution showing an example of a preferred embodiment of an apparatus for laser cooling of atoms according to the present invention (hereinafter referred optionally to “laser cooling apparatus according to the present invention”). The laser cooling apparatus according to the present invention shown in FIG. 5 may be used in case of cooling a variety of atoms such as silicon atoms, and germanium atoms.

Namely, the laser cooling apparatus 50 according to the invention is composed of a coherent light source section 52 for producing coherent light having a predetermined wavelength and outputting it, and a polarized light control section 54 for changing polarized light of the coherent light output from the coherent light source 52.

The coherent light source section 52 of the laser cooling apparatus 50 according to the invention may be constituted in, for example, a two-stage external resonator type wavelength converting section for producing laser beams having a predetermined wavelength as coherent light and outputting the same. On the other hand, the polarized control section 54 of the laser cooling apparatus 50 according to the invention may be constituted in, for example, a phase modulator obtained by combining an electro-optic device constituted by a birefringent crystal, which can control time-varyingly polarization, with a wavelength plate. It is to be noted that the electro-optic device means a material wherein its refractive index is changed by an electric field applied to the birefringent crystal thereby to change a phase of the laser beams passing through there.

A case where silicon atoms are cooled by the use of the laser cooling apparatus 50 of the present invention will be described hereinafter wherein the above-described two-stage external resonator type wavelength converting section is used as the coherent light source section 52, and the above-described phase modulator is used as the polarized light control section 54. In this case, laser beam having 746 nm wavelength (for example, ring type single-mode titanium sapphire laser beam of Nd:YVO₄ second harmonics excitation having 746 nm wavelength may be used) is introduced in the external resonator in a first stage of the external resonator type wavelength converting section being the coherent light source 52, whereby second harmonics having 373 nm wavelength are allowed to produce by means of an LBO crystal disposed in the resonator at 40% conversion efficiency.

Successively, the laser beam of 373 nm wavelength and laser beam having 780 nm wavelength (for example, single-mode semiconductor laser beam having 780 nm wavelength may be used) are introduced in a second resonator in a second stage of the external resonator type converting section, and the laser beams containing two wavelengths are resonated simultaneously to increase respective optical powers, whereby light beam of 252 nm, which exceeds 60 mW, is allowed to produce as a result of sum frequency mixing by means of a BBO crystal in the resonator.

In the polarized control section 54, a phase modulator is composed by combining an electro-optic device prepared from a birefringent crystal with a wavelength plate, whereby polarization is controlled time-varyingly.

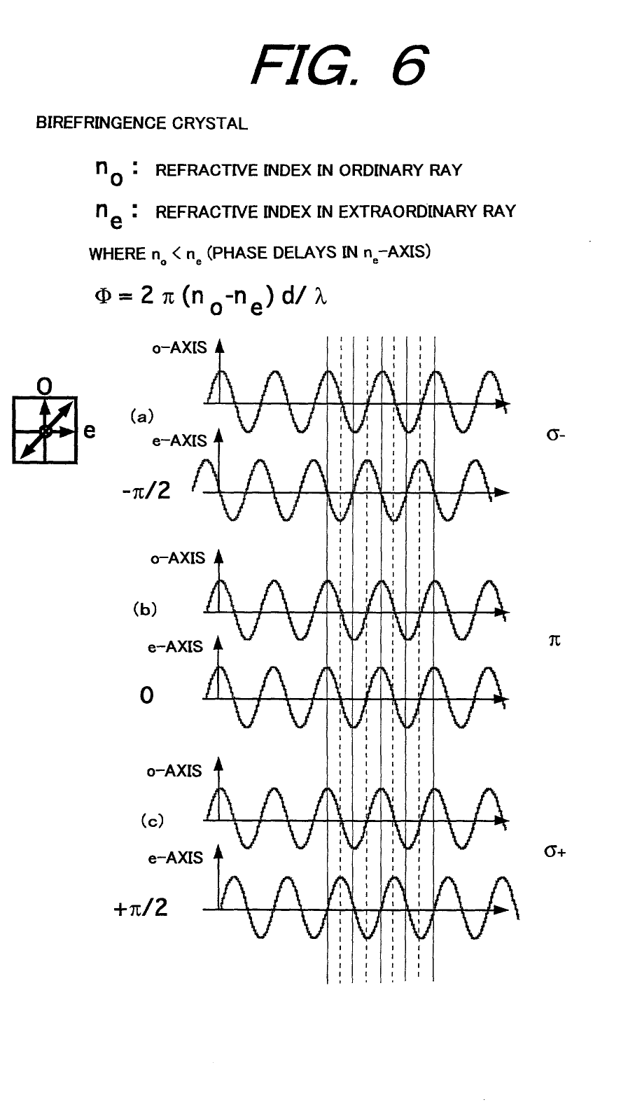

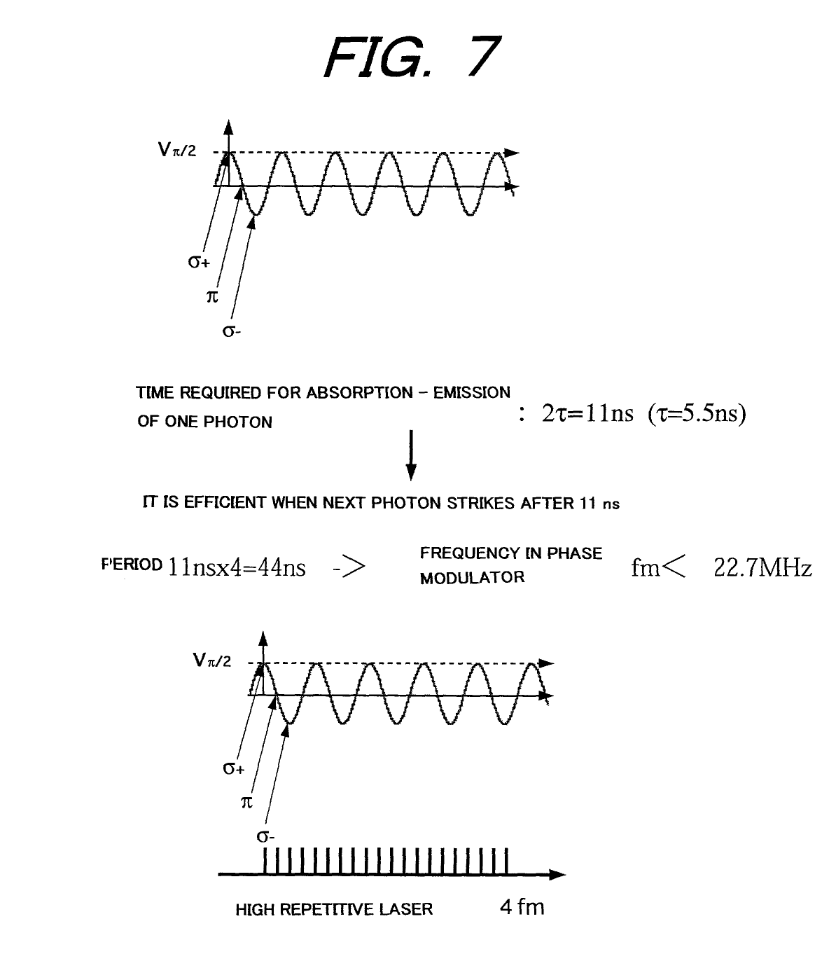

As described above, an electro-optic device means a material wherein its refractive index is changed by an electric field applied to a birefringent crystal thereby to change a phase of the laser beams passing through there. In FIGS. 6(a) through 6(c), each situation of changes in phases of laser beams by means of a birefringent crystal is shown. By means of a birefringent crystal, when each phase deviates by −π/2 between an o-axis and an e-axis as shown in FIG. 6(a), left-handed polarized light (σ−) is realized. Furthermore, as shown in FIG. 6(b), there is no deviation between the o- and thee-axes, linearly polarized light (π) is realized. Moreover, as shown in FIG. 6(c), when each phase deviates by π/2 between the o- and the e-axes, right-handed polarized light (σ+) is realized.

As shown in FIG. 7, a time required for absorbing and emitting one photon is twice longer than spontaneous emission lifetime (τ)

When an explanation is specifically made on silicon atom, its spontaneous emission lifetime is 5.5 ns (nano seconds); a twice-larger value of spontaneous emission lifetime (τ) is 11 ns (2τ=11 ns).

Accordingly, when photon is hit on silicon atom in each 11 ns, one photon is efficiently absorbed and emitted, whereby the silicon atom is cooled.

In this case, since a period is “11 ns×4=44 ns”, the silicon atom can be efficiently cooled, when a frequency fm is lower than 22.7 MHz in a phase modulator as the polarized light control section 54.

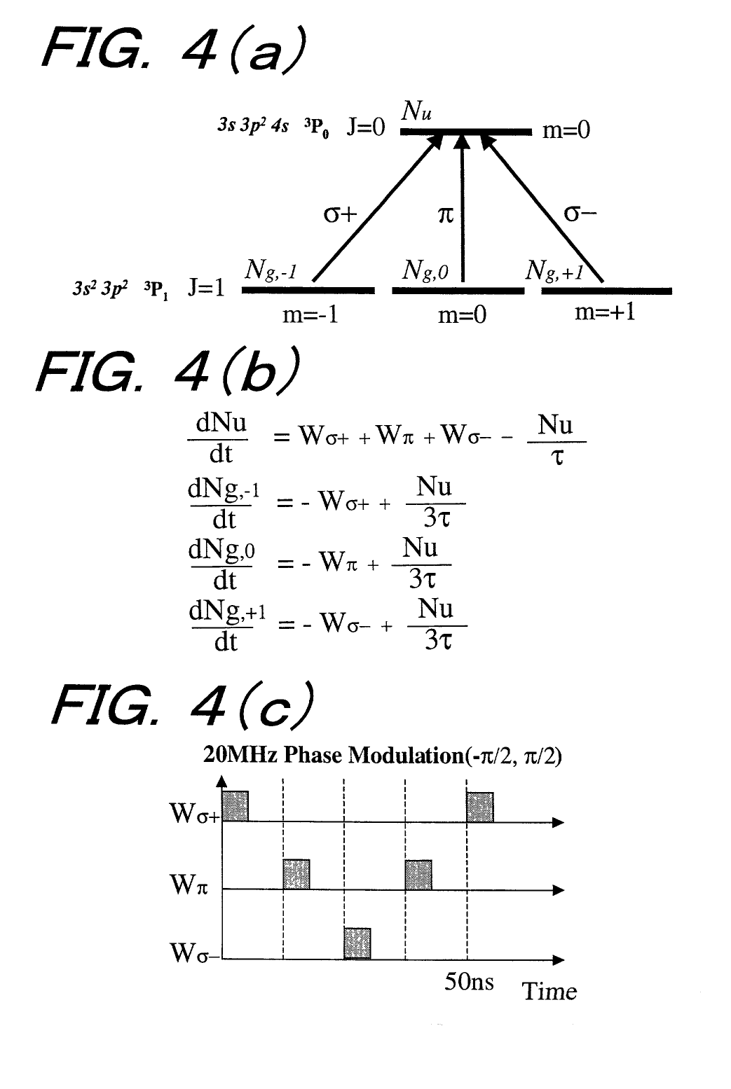

As shown in FIG. 4(c), when polarized light of laser beam emitted to silicon atoms is changed sequentially from right-handed polarized light (σ−) to left-handed polarized light (σ+) through linearly polarized light (τ) in each 2.5 ns corresponding to a time interval substantially twice longer than its spontaneous emission lifetime, the silicon atoms can be cooled.

When light beam in one direction of polarized light is used in case of laser cooling of silicon atoms, cooling cycles, which have been in two dark levels, among three magnetic subsidiary levels of cooling lower levels are not closed. However, when the directions of polarized light are changed time-varyingly as described above, the cooling cycles can be closed without involving any dark level. Thus, it becomes possible to laser-cool silicon atoms.

The coherent light source section 52 for coherent light may be arranged in such that a coherent light source wherein a CW laser (continuous laser) is employed and a coherent light source wherein a picosecond laser is employed are selected properly in response to a case where silicon atoms are to be decelerated by means of scattering force or a case where silicon atoms are to be cooled by means of scattering force.

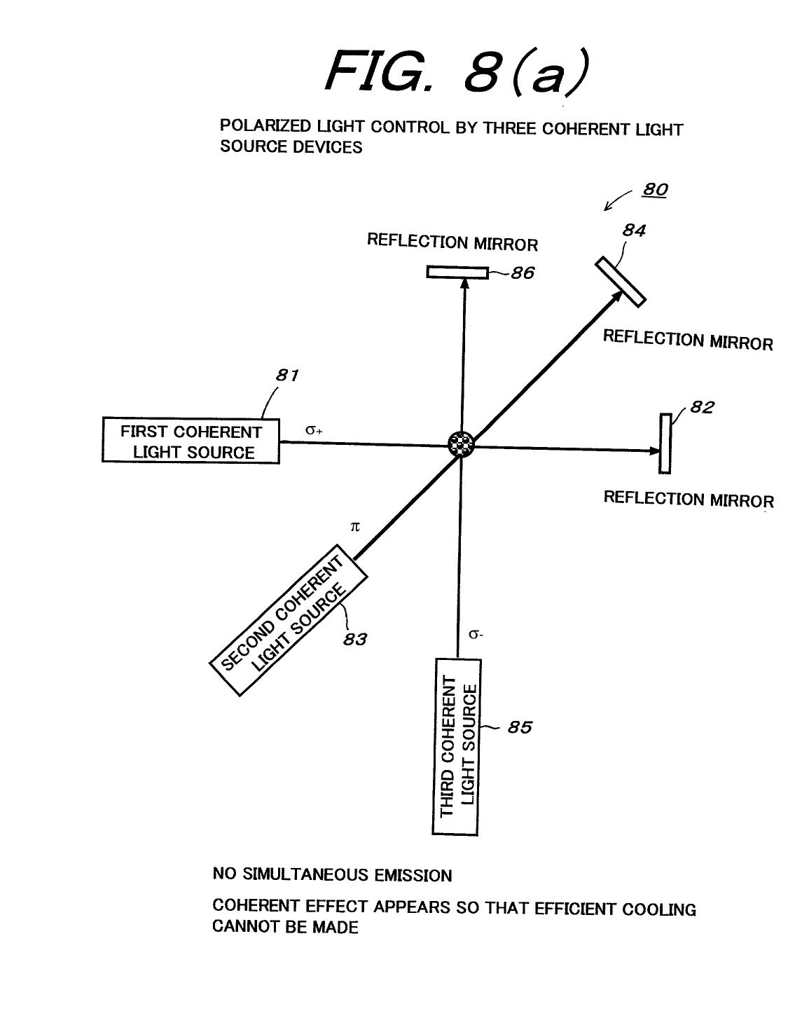

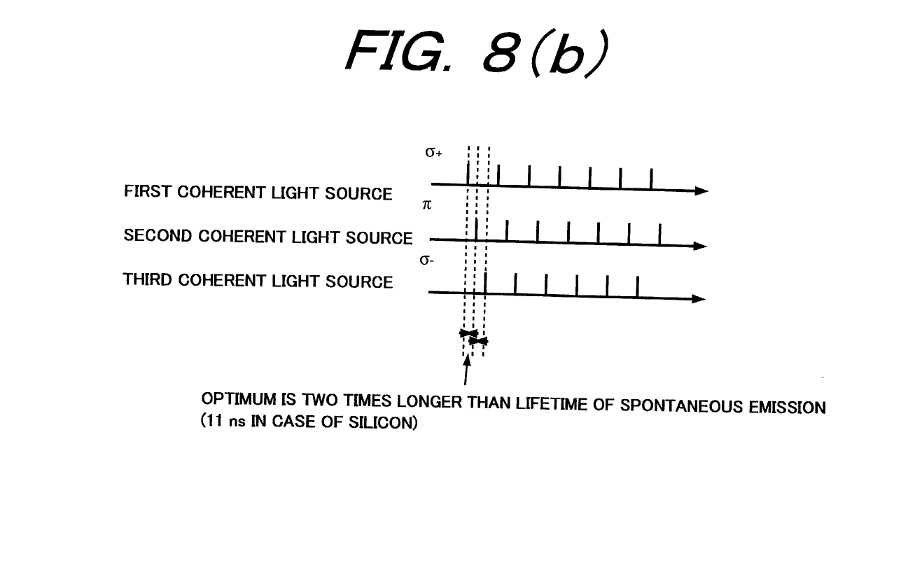

In FIG. 5, although the embodiment wherein atoms are subjected to laser cooling by the use of the single coherent light source section 52, more specifically one coherent light source device has been described, another embodiment wherein a variety of atoms such as silicon atoms, and germanium atoms are subjected to laser cooling by the use of a plurality of coherent light source sections, more specifically three coherent light source devices will be described by referring to FIGS. 8(a) and 8(b).

Namely, a laser cooling apparatus 80 according to the present invention includes a first coherent light source device 81 as a first coherent light source section for emitting coherent light of right-handed polarized light (σ+) (e.g., laser beam), a reflecting mirror 82 for reflecting the coherent light emitted from the first coherent light source device 81, a second coherent light source device 83 as a second coherent light source section for emitting coherent light of linearly polarized light (n) (e.g., laser beam), a reflecting mirror 84 for reflecting the coherent light emitted from the second coherent light source device 83, a third coherent light source 85 as a third coherent light source section for emitting coherent light of left-handed polarized light (σ−) (e.g., laser beam), and a reflecting mirror 86 for reflecting the coherent light emitted from the third coherent light source device 85.

In the laser cooling apparatus 80 according to the present invention shown in FIG. 8(a), coherent light may be emitted alternately in order of precedence from the first coherent light source device 31, the second coherent light source device 83, and the third coherent light source device 85 with a time interval corresponding to substantially twice longer than spontaneous emission lifetime of the atoms.

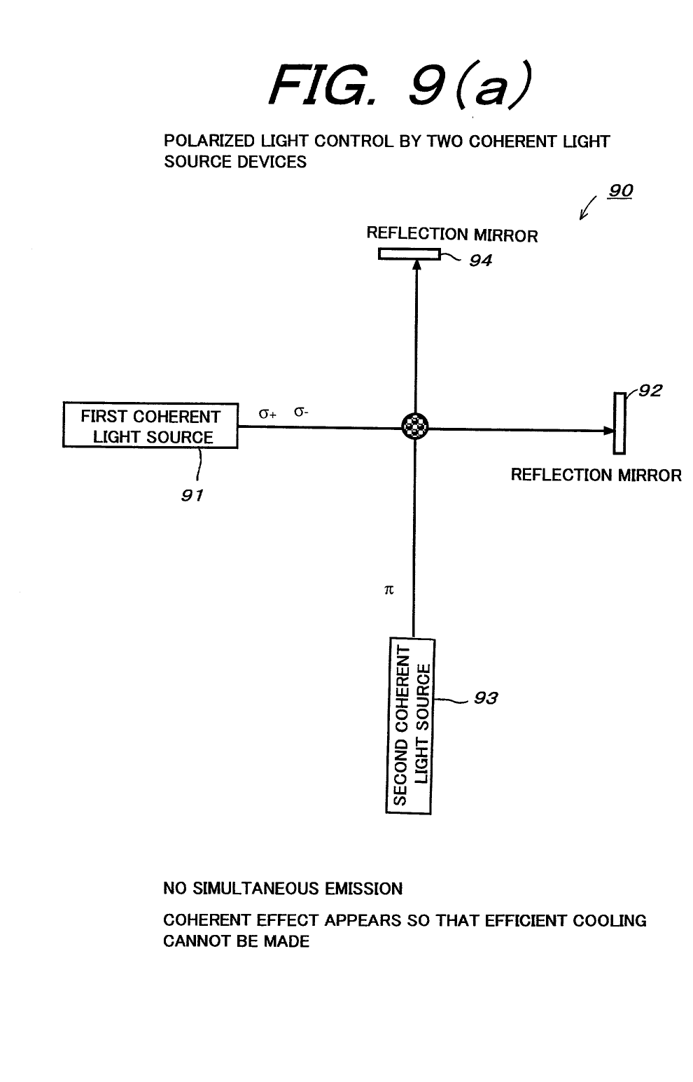

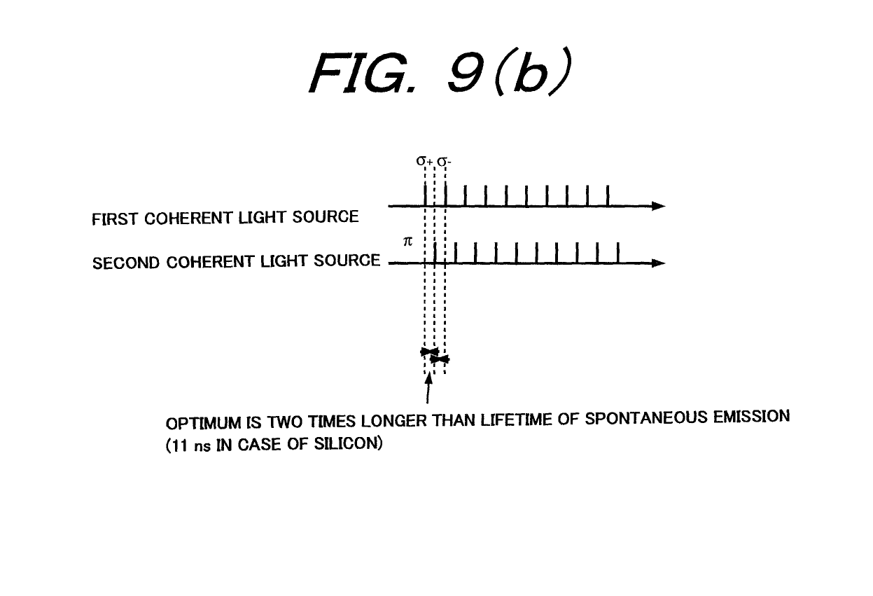

Next, a further embodiment wherein a variety of atoms such as silicon atoms, and germanium atoms are laser-cooled by the use of a plurality of coherent light source sections, more specifically two coherent light source devices will be described by referring to FIGS. 9(a) and 9(b).

Namely, a laser cooling apparatus 90 according to the present invention shown in FIG. 9(a) includes a first coherent light source device 91 as a first coherent light source section for emitting coherent light of polarized light (e.g., laser beam) while switching alternately right-handed polarized light (σ+) and left-handed polarized light (σ−), a reflecting mirror 92 for reflecting the coherent light emitted from the first coherent light source device 91, a second coherent light source device 93 as a second coherent light source section for emitting coherent light of linearly polarized light (π) (e.g., laser beam), and a reflecting mirror 94 for reflecting the coherent light emitted from the second coherent light source device 93.

In the laser cooling apparatus 90 according to the present invention shown in FIG. 9(a), coherent light is emitted with a time interval corresponding to substantially twice longer than spontaneous emission lifetime of each atom in accordance with the following orders as shown in FIG. 9(b):

“Emission of coherent light of right-handed polarized light (σ+) from the first coherent light source device 90→emission of coherent light of linearly polarized light (π) from the second coherent light source device 93→emission of coherent light of left-handed polarized light (σ−) from the first coherent light source device 90→emission of coherent light of linearly polarized light (π) from the second coherent light source device 93 emission of coherent light of right-handed polarized light (σ+) from the first coherent light source device 90→emission of coherent light of linearly polarized light (π) from the second coherent light source device 93→emission of coherent light of left-handed polarized light (σ−) from the first coherent light source device 90→, . . . , ”

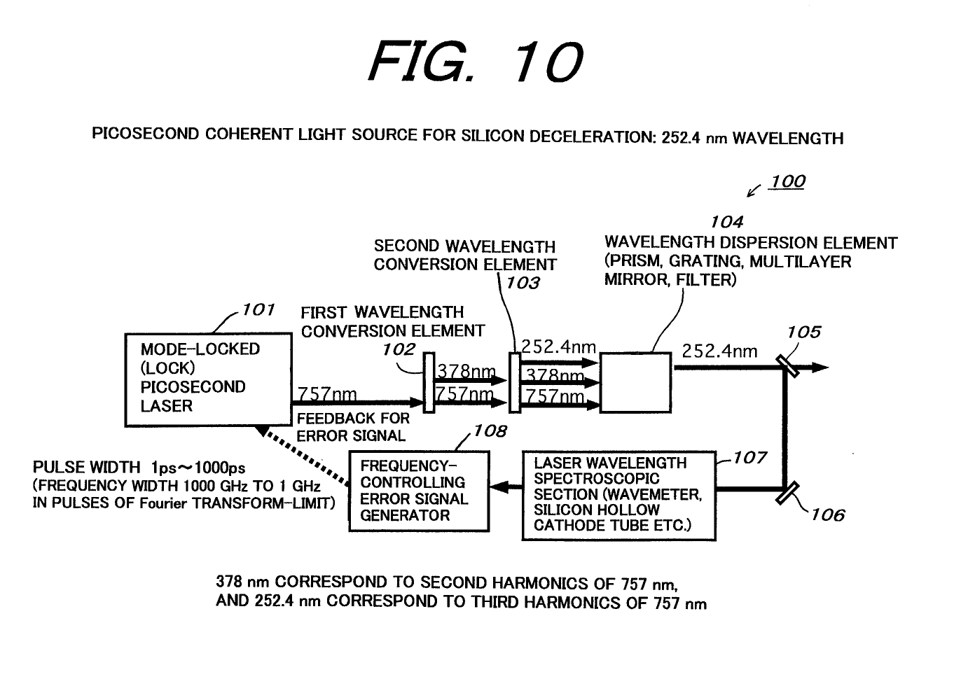

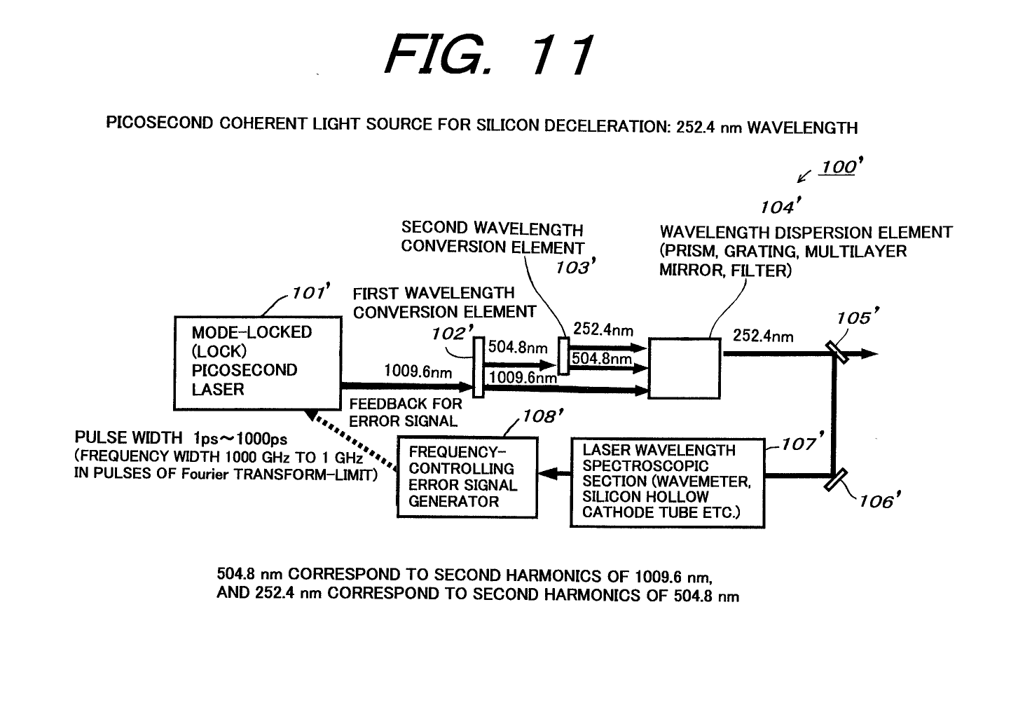

In the following, an example of a preferred embodiment of a coherent light source used for laser cooling of atoms will be described by referring to FIG. 10.

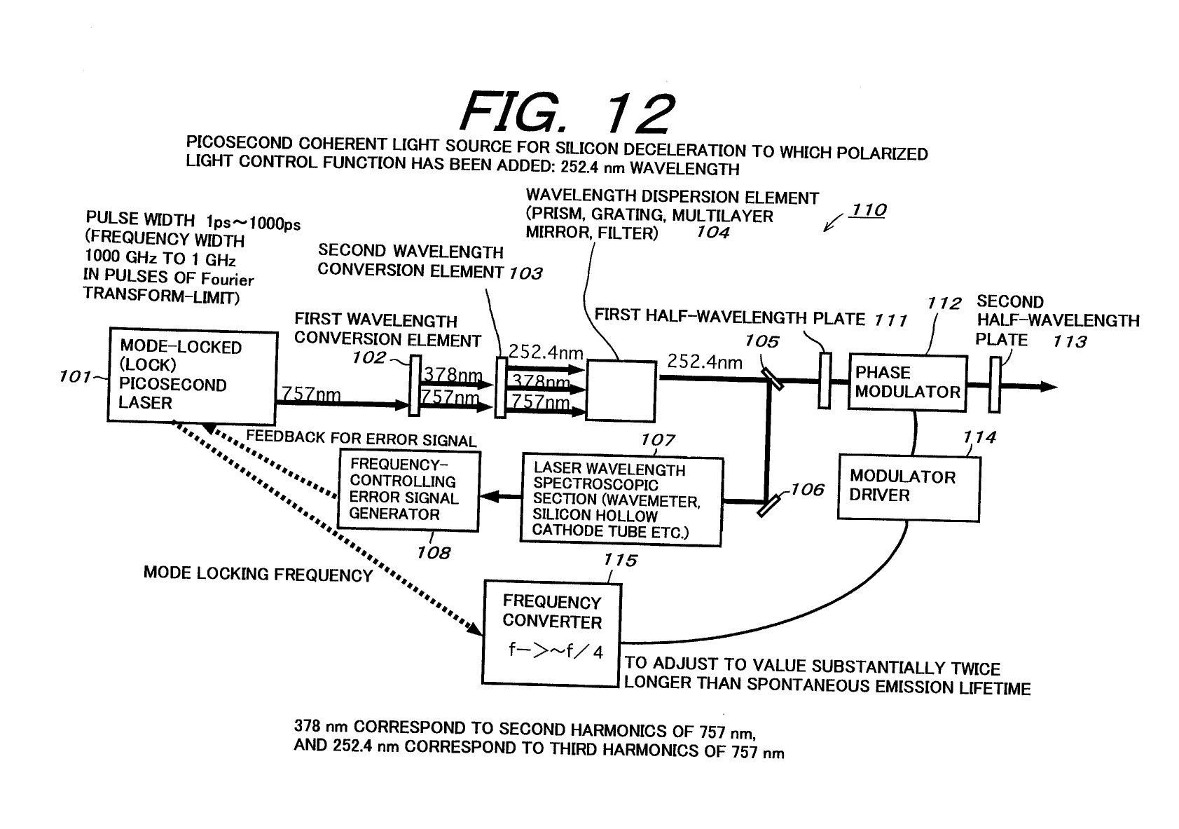

An example of the preferred embodiment of a coherent light source used for laser cooling of atoms shown in FIG. 10 is a light source for decelerating silicon atoms by means of scattering force (hereinafter referred to as “picosecond coherent light source used for silicon deceleration”, and it may be used, for example, as the coherent light source section 52 in the laser cooling apparatus 50 of the present invention shown in FIG. 5; the first coherent light source section, the second coherent light source section, or the third coherent light source section in the laser cooling apparatus 80 according to the invention shown in FIG. 8(a); and the first coherent light source section or the second coherent light source section shown in FIG. 9(a), as a matter of course. Besides, the above-described light source may be used as a coherent light source in a laser cooling apparatus according to the present invention shown in FIG. 12, which will be described later.

A picosecond coherent light source used for silicon deceleration 100 shown in FIG. 10 is constituted so as to be capable of emitting coherent light of 252.4 nm wavelength, which includes a mode-locked (lock) picosecond laser 101, a first wavelength conversion element 102, a second wavelength conversion element 103, a wavelength dispersion element 104, a partial reflection mirror 105, a total reflection mirror 106, a laser wavelength spectroscopic section 107, and a frequency-controlling error signal generator 108. Further, a feedback circuit for inputting an error signal to the mode-locked (lock) picosecond laser 101 as a feedback signal is composed of the partial reflection mirror 105, the total reflection mirror 106, the laser wavelength spectroscopic section 107, and the frequency-controlling error signal generator 108.

In this case, the mode-locked (lock) picosecond laser 101 outputs coherent light having a pulse width of from 1 ps to 1000 ps at 757 nm wavelength (a frequency zone of from 1000 GHz to 1 GHz in Fourier transform-limited pulse).

First, coherent light of 757 nm wavelength output from the mode-locked (lock) picosecond laser 101 is input to the first wavelength conversion element 102, so that coherent light of 757 nm wavelength and coherent light being its second harmonics of 378 nm wavelength are obtained by means of the first wavelength conversion element 102.

Then, coherent light of 757 nm wavelength and coherent light of 378 nm wavelength output from the first wavelength conversion element 102 are input to the second wavelength conversion element 103, so that coherent light of 757 nm wavelength, coherent light being its second harmonics of 378 nm wavelength, and coherent light being its third harmonics of 252.4 nm wavelength are obtained by means of the second wavelength conversion element 103.

Moreover, when coherent light of 757 nm wavelength, coherent light of 378 nm wavelength, and coherent light of 252.4 nm wavelength output from the second wavelength conversion element 103 are input to the wavelength dispersion element 104, only coherent light of 252.4 nm wavelength is output from the wavelength dispersion element 104 to transmit the partial reflection mirror 105, and the resulting light is used for deceleration of silicon atoms by means of scattering force. In this case, the wavelength dispersion element 104 is prepared from, for example, prism, grating, multilayer mirror, filter or the like.

On one hand, coherent light having 252.4 nm wavelength reflected by the partial reflection mirror 105 is reflected by the total reflection mirror 106 to be input to the laser wavelength spectroscopic section 107 composed of a wavemeter, a silicon hollow cathode tube and the like.

A wavelength of the coherent light thus input is measured by the laser wavelength spectroscopic section 107, and the measured result is input to the frequency-controlling error signal generator 108.

The frequency-controlling error signal generator 108 feedbacks an error signal on the basis of the measured result input in such that the mode-locked (lock) picosecond laser 101 produces always coherent light having 757 nm wavelength.

As a result of such feedback control, it becomes possible to emit always coherent light of 252.4 nm wavelength to silicon atoms.

FIG. 11 shows an example of another preferred embodiment of the picosecond coherent light source used for silicon deceleration 100 shown in FIG. 10 wherein the same or equivalent components as or to those of FIG. 10 are designated by such numerals each obtained by adding a sign “′” to a corresponding reference numeral in FIG. 10, and the detailed description therefor will be omitted.

A picosecond coherent light source used for silicon deceleration 100′ shown in FIG. 11 is constituted so as to be capable of emitting coherent light having 252.4 nm, which includes a mode-locked (lock) picosecond laser 101′, a first wavelength conversion element 102′, a second wavelength conversion element 103′, a wavelength dispersion element 104′, a partial reflection mirror 105′, a total reflection mirror 106′, a laser wavelength spectroscopic section 107′, and a frequency-controlling error signal generator 108′. Further, a feedback circuit for inputting an error signal to the mode-locked (lock) picosecond laser 101′ as a feedback signal is composed of the partial reflection mirror 105′, the total reflection mirror 106′, the laser wavelength spectroscopic section 107′, and the frequency-controlling error signal generator 108′.

In this case, the mode-locked (lock) picosecond laser 101′ outputs coherent light having a pulse width of from 1 ps to 1000 ps at 1009.6 nm wavelength (a frequency zone of from 1000 GHz to 1 GHz in Fourier transform-limited pulse).

First, coherent light of 1009.6 nm wavelength output from the mode-locked (lock) picosecond laser 101′ is input to the first wavelength conversion element 102′, so that coherent light of 1009.6 nm wavelength and coherent light being its second harmonics of 504.8 nm wavelength are obtained by means of the first wavelength conversion element 102′.

Then, coherent light of 504.8 nm wavelength output from the first wavelength conversion element 102′ is input to the second wavelength conversion element 103′, so that coherent light of 504.8 nm wavelength, and coherent light being its second harmonics of 252.4 nm wavelength are obtained by means of the second wavelength conversion element 103′ (252.4 nm wavelength corresponds to fourth harmonics of 1009.6 nm wavelength).

Moreover, when coherent light of 504.8 nm wavelength and coherent light of 252.4 nm wavelength output from the second wavelength conversion element 103′ as well as coherent light of 1009.6 nm wavelength output from the first wavelength conversion element 102′ are input to the wavelength dispersion element 104′, only coherent light of 252.4 nm wavelength is output from the wavelength dispersion element 104′ to transmit the partial reflection mirror 105′, and the resulting light is used for deceleration of silicon atoms by means of scattering force. In this case, the wavelength dispersion element 104′ is prepared from, for example, prism, grating, multilayer mirror, filter or the like.

On one hand, coherent light having 252.4 nm wavelength reflected by the partial reflection mirror 105′ is reflected by the total reflection mirror 106′ to be input to the laser wavelength spectroscopic section 107′ composed of a wavemeter, a silicon hollow cathode tube and the like.

A wavelength of the coherent light thus input is measured by the laser wavelength spectroscopic section 107′, and the measured result is input to the frequency-controlling error signal generator 108′.

The frequency-controlling error signal generator 108′ feedbacks an error signal on the basis of the measured result input in such that the mode-locked (lock) picosecond laser 101′ produces always coherent light having 1009.6 nm wavelength.

As a result of such feedback control, it becomes possible to emit always coherent light of 252.4 nm wavelength to silicon atoms.

In the following, an example of a preferred embodiment of a laser cooling apparatus according to the present invention wherein one picosecond coherent light source used for silicon deceleration 100 shown in FIG. 10 is used as a coherent light source used for laser cooling of atoms (a picosecond coherent light source used for silicon deceleration to which polarized light control function has been added) will be described by referring to FIG. 12 wherein the same or equivalent components as or to those of FIG. 10 are designated by the same reference numerals those used in FIG. 10, and the detailed description therefor will be omitted.

On a laser cooling apparatus 110 according to the present invention, a first half-wavelength plate 111, a phase modulator 112, a second half-wavelength plate 113, a modulator driver 114, and a frequency converter 115 are mounted as a polarized light control section.

The frequency converter 115 outputs a control signal to the modulator driver 114 in such that a modulating signal is output to the phase modulator 112 from the modulator driver 114 in a substantially twice longer period of spontaneous emission lifetime of silicon atom, when a mode locking frequency is input to the frequency converter 115 and the mode locking frequency is subjected to frequency conversion. In other words, polarized light of coherent light output from the phase modulator 112 is set to be switched in a period substantially twice longer than spontaneous emission lifetime of silicon atom.

More specifically, coherent light of 252.4 nm wavelength is controlled by the polarized light control section so as to be switched in a frequency substantially twice longer than the spontaneous emission lifetime of silicon atom.

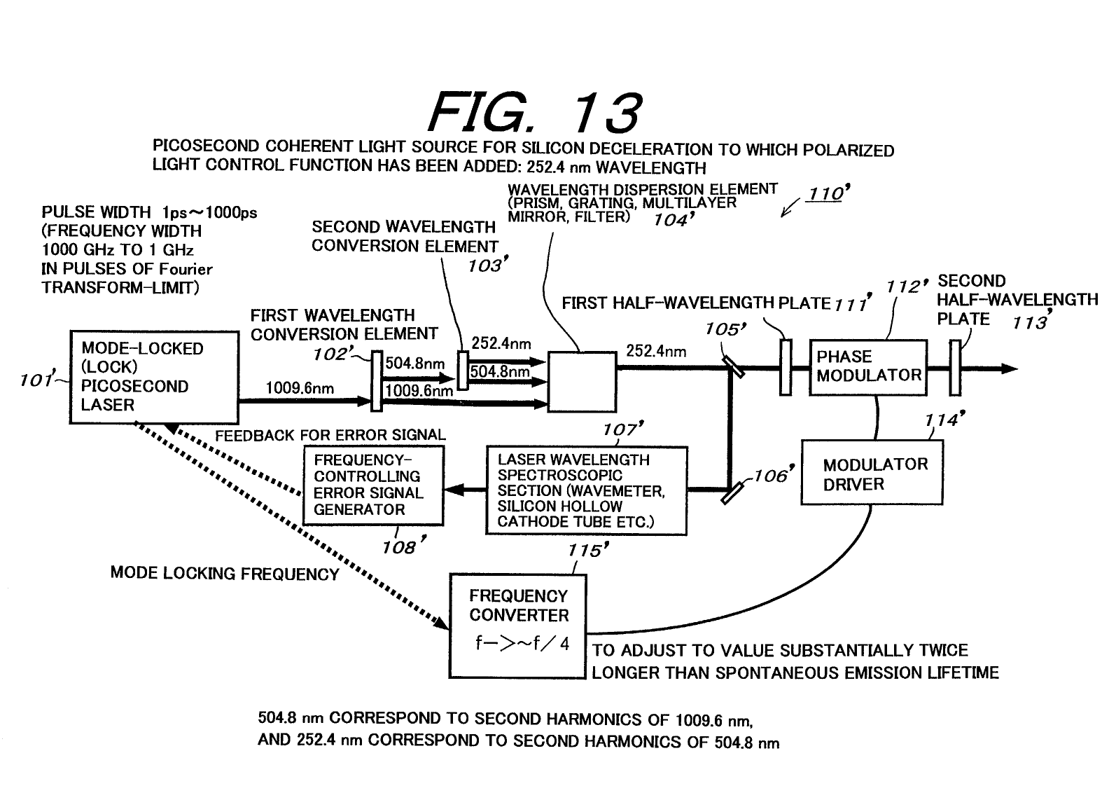

In the following, an example of another preferred embodiment of a laser cooling apparatus according to the present invention shown in FIG. 12 wherein one picosecond coherent light source used for silicon deceleration 100′ shown in FIG. 11 is used as a coherent light source used for laser cooling of atoms (a picosecond coherent light source used for silicon deceleration to which polarized light control function has been added) will be described by referring to FIG. 13 wherein the same or equivalent components as or to those of FIG. 11 are designated by the same reference numerals those used in FIG. 11, besides, the same or equivalent components as or to those of FIG. 12 are designated by such numerals each obtained by adding a sign “‘” to a corresponding reference numeral in FIG. 12, and the detailed description for these components will be omitted.

On a laser cooling apparatus 110′ according to the present invention, a first half-wavelength plate 111′ a phase modulator 112′, a second half-wavelength plate 113′, a modulator driver 114′, and a frequency converter 115′ are mounted as a polarized light control section.

The frequency converter 115′ outputs a control signal to the modulator driver 114′ in such that a modulating signal is output to the phase modulator 112 ′ from the modulator driver 114 in a substantially twice longer period of spontaneous emission lifetime of silicon atom, when a mode locking frequency is input to the frequency converter 115′ and the mode locking frequency is subjected to frequency conversion. In other words, polarized light of coherent light output from the phase modulator 112′ is set to be switched in a period substantially twice longer than spontaneous emission lifetime of silicon atom.

More specifically, coherent light of 252.4 nm wavelength is controlled by the polarized light control section so as to be switched in a frequency substantially twice longer than the spontaneous emission lifetime of silicon atom.

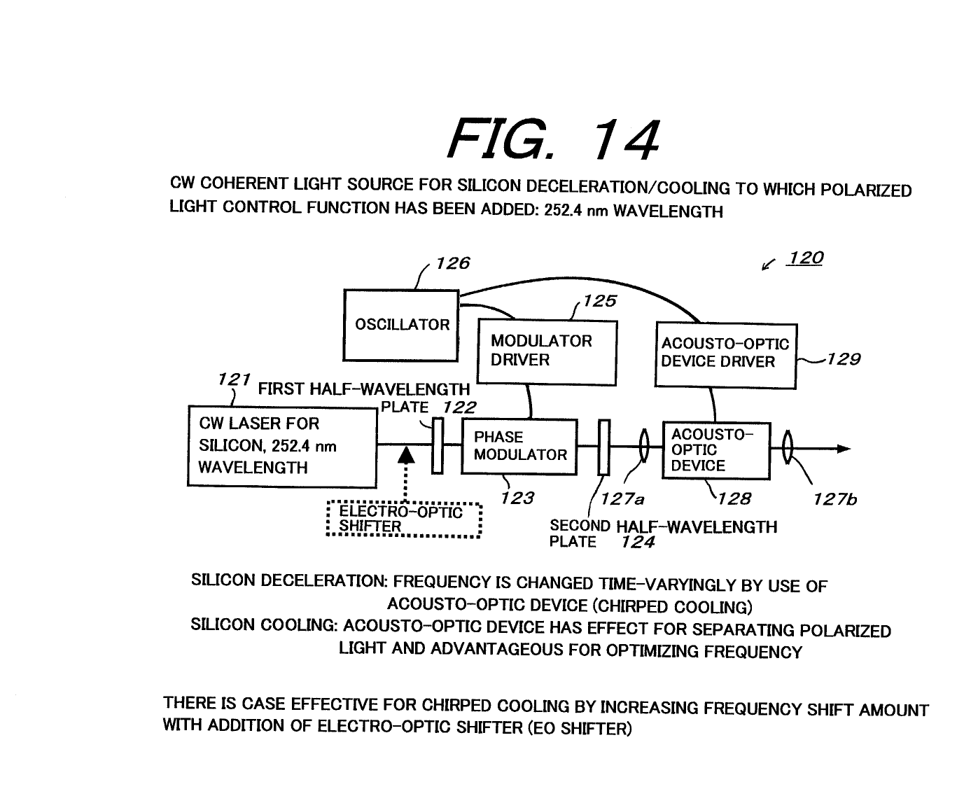

Next, an example of a preferred embodiment of a laser cooling apparatus wherein a CW laser is used as a coherent light source utilized for laser cooling of atoms producing coherent light having a predetermined wavelength (a CW coherent light source used for silicon deceleration/cooling to which polarized light control function has been added) will be described by referring to FIG. 14.

In a laser cooling apparatus 120 according to the present invention shown in FIG. 14, one CW laser of 252.4 nm wavelength is specifically employed as the above-described CW laser.

The laser cooling apparatus 120 of the present invention can function to effect both deceleration by means of scattering force and cooling by means of scattering force with respect to silicon atoms.

Namely, the laser cooling apparatus 120 of the invention is provided with a CW laser 121 of 252.4 nm wavelength for silicon use as a coherent light source used for laser cooling of atoms, and a polarized light control section including a first half-wavelength plate 122, a phase modulator 123, a second half-wavelength plate 124, a modulator driver 125, an oscillator 126, a first lens 127a, an acousto-optic device 128, a second lens 127b, and an acousto-optic device driver 129.

In the case where silicon atoms are decelerated by scattering force, a frequency is changed time-varyingly by the use of the acousto-optic device 128 to implement chirped cooling.

On one hand, in the case where silicon atoms are cooled by scattering force, the acousto-optic device 128 has an effect for separating time-varyingly polarized light and is convenient for optimizing a frequency.

There is a case that is effective for chirped cooling to install additionally an electro-optic shifter (EO shifter) between the CW laser for silicon use 121 and the first half-wavelength plate 122 to increase a frequency shift amount. Accordingly, such electro-optic shifter may optionally be disposed in the above-described position.

As the CW laser for silicon use 121 of 252.4 nm wavelength, for example, a fiber laser or fourth harmonics of a semiconductor laser of 1009.6 nm may be used, or second harmonics of a semiconductor laser of 504.8 nm wavelength or a semiconductor laser of 252.4 nm wavelength may be used.

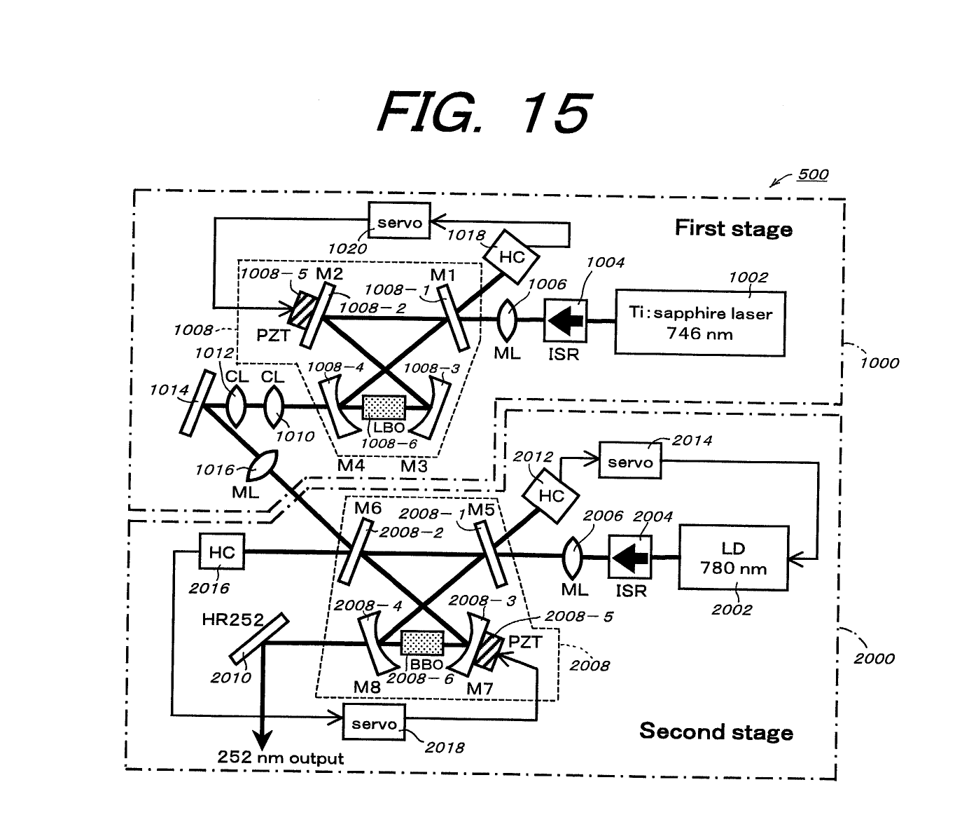

A constitution of a coherent light source that can be used as the above-described CW laser for silicon use 121, i.e., a coherent light source producing CW laser beam having wavelengths in a deep ultraviolet region that is applicable for a coherent light source used for laser cooling of atoms will be described herein by referring to FIGS. 15 through 17.

FIG. 15 shows a schematic constitution of a coherent light source 500 that is applicable for the CW laser for silicon use 121. The coherent light source 500 is constituted from a two-stage external resonator type wavelength conversion system, which is composed of a first stage external resonator type wavelength conversion system 1000 functioning as a first laser beam producing system for producing laser beam having a first wavelength, and a second stage external resonator type wavelength conversion system 2000 functioning as a second laser beam producing system, which produces laser beam having a second wavelength, and in addition, introduces the laser beam having the first wavelength produced in the first stage external resonator type wavelength conversion system 1000 thereinto to generate laser beam having a third wavelength by means of sum frequency mixing of the laser beam of the first wavelength and the laser beam of the second wavelength at high efficiency.

The first stage external resonator type wavelength conversion system 1000 of the coherent light source 500 includes a ring type single mode titanium sapphire laser (Ti:sapphire laser 746 nm) 1002 excited by second harmonics of Nd:YVO₄ laser to output laser beam of 746 nm wavelength; an isolator (IRS) 1004 for adjusting the laser beam output from the ring type single mode titanium sapphire laser 1002; a mode matching lens (ML) 1006 for effecting mode matching of the laser beam output from the isolator 1004; a resonator main body 1008 for inputting the laser beam output from the mode matching lens 1006; a first condensing lens 1010 for condensing the laser beam output from the resonator main body; a second condensing lens 1012 for further condensing the laser beam output from the first condensing lens 1010; a total reflection mirror 1014 for changing an optical path of the laser beam output from the second condensing lens 1012; a mode matching lens (ML) for mode-matching the laser beam output from the total reflection mirror 1014; an error signal generator (HC) 1018 for utilizing polarized light of the laser beam that transmitted through an input coupling mirror (M1) 1008-1 (which will be described later) constituting the resonator main body 1008; and a servo mechanism for driving a piezo element (PZT) 1008-5 (which will be described later) that moves minutely a disposed position of a total reflection mirror (M2) 1008-2 (which will be described later) constituting the resonator main body 1008 based on an error signal output from the error signal generator 1018.

In this case, the resonator main body 1008 involves the input coupling mirror 1008-1 for introducing the laser beam of 746 nm laser beam output from the mode matching lens 1006 into the resonator main body 1008, the total reflection mirror 1008-2 a disposed position of which is moved minutely by driving the piezo element 1008-5, a total reflection mirror (M3) 1008-3, an output mirror 1008-4 for outputting laser beam outside the resonator main body 1008, the piezo element 1008-5 for moving minutely a disposed position of the total reflection mirror 1008-2, and a LiB₃O₅ crystal (LBO) 1008-6 disposed on an optical path extending from the total reflection mirror 1008-3 and the output mirror 1008-4.

The LiB₃O₅ crystal 1008-6 produces second harmonics (373 nm wavelength) of laser beam of 746 nm wavelength. Furthermore, the LiB₃O₅ crystal 1008-6 has an excision angle of “θ=90°” and “φ=37.5°”, a crystal length of 15 mm, and on an input side (a side of the total reflection mirror 1008-3) of which antireflection coating of 746 nm wavelength has been applied, while on an output side (a side of the output mirror 1008-4) of which antireflection coating of 746 nm wavelength as well as antireflection coating of 373 nm wavelength have been applied.

The input coupling mirror 1008-1 is arranged in such that 2% of laser beam of 746 nm wavelength are transmitted, laser beam of 373 nm wavelength is not transmitted, 98% of laser beam of 746 nm wavelength are reflected, and 99.9% or more of laser beam of 373 nm wavelength are reflected. The total reflection mirror 1008-2 is arranged in such that laser beam of 746 nm wavelength is not transmitted, laser beam of 373 nm wavelength is not transmitted, 99.9% or more of laser beam of 746 nm wavelength are reflected, and 99.9% or more of laser beam of 373 nm wavelength are reflected. Moreover, the total reflection mirror 1008-3 is arranged in such that laser beam of 746 nm wavelength is not transmitted, laser beam of 373 nm wavelength is not transmitted, 99.9% or more of laser beam of 746 nm wavelength are reflected, and 99.9% or more of laser beam of 373 nm wavelength are reflected. Furthermore, the output mirror 1008-4 on which multilayer coating has been doubly applied is arranged in such that 95% of laser beam of 373 nm wavelength are transmitted, and 99.9% or more of laser beam of 746 nm wavelength are reflected.

The above-described four mirrors (the input coupling mirror 1008-1, the total reflection mirror 1008-2, the total reflection mirror 1008-3, and the output mirror 1008-4) are disposed so as to make such an optical path where in laser beam of 746 nm wavelength that was output from the mode matching lens 1006 transmits the input coupling mirror 1008-1 to which the laser beam was input, proceeds to the reflection mirror 1008-2, from which proceeds to the total reflection mirror 1008-3, from which transmits the LiB₃O₅ crystal 1008-6, proceeds to the output mirror 1008-4, and from which proceeds to the input coupling mirror 1008-1. Accordingly, an optical path of laser beam in a region surrounded by the input coupling mirror 1008-1, the total reflection mirror 1008-2, the total reflection mirror 1008-3, and the output mirror 1008-4 exhibits a bow-tie shape.

Ninety-five (95)% of transmitted laser beam of 373 nm wavelength among the laser beams, which passed through the LiB₃O₅ crystal 1008-6 from the total reflection mirror and proceeded to the output mirror 1008-4, proceed to the first condensing lens 1010. Further, two (2)% of transmitted laser beam of 746 nm wavelength among the laser beams, which proceeded to the input coupling mirror 1008-2 from the output mirror 1008-4, proceed to the error signal generator 1018.

The second stage external resonator type wavelength conversion system 2000 of the coherent light source 500 includes a single mode semiconductor laser outputting laser beam of 780 nm wavelength (LD 780 nm) 2002; anisolator (IRS) 2004 for adjusting the laser beam output from the single mode semiconductor laser 2002; a mode matching lens (ML) 2006 for effecting mode matching of the laser beam output from the isolator 2004; a resonator main body 2008 for inputting the laser beam output from the mode matching lens 2006; a high reflection mirror (HR 252) 2010 for reflecting the laser beam of 252 nm output from the resonator main body 2008 to introduce the reflected laser beam outside the coherent light source 500; an error signal generator (HC) 2012 for utilizing polarized light of the laser beam that transmitted through an input coupling mirror (M5) 2008-1 (which will be described later) constituting the resonator main body 2008; a servo mechanism 2014 for driving the single mode semiconductor laser 2002 based on an error signal output from the error signal generator 2012; an error signal generator (HC) 2016 for utilizing polarized light of the laser beam that transmitted through an input coupling mirror (M5) 2008-2 (which will be described later) constituting the resonator main body 2008; and a servo mechanism 2018 for driving a piezo element (PZT) 2008-5 that moves minutely a disposed position of a total reflection mirror (M7) 2008-3 (which will be described later) constituting the resonator main body 2008 based on an error signal output from the error signal generator 2016.

In this case, the resonator main body 2008 involves the input coupling mirror 2008-1 for introducing the laser beam of 780 nm laser beam output from the mode matching lens 2006 into the resonator main body 2008, the input coupling mirror 2008-2 for introducing the laser beam of 373 nm wavelength output from the first stage external resonator type wavelength conversion system 1000 into the resonator main body 2008, the total reflection mirror (M7) 2008-3 a disposed position of which is moved minutely by driving the piezo element 2008-5, an output mirror (M8) 2008-4 for outputting laser beam outside the resonator main body 2008, the piezo element 2008-5 for moving minutely a disposed position of the total reflection mirror 2008-3, and a β-BaB₂O₄ crystal (BBO) 2008-6 disposed on an optical path extending from the total reflection mirror 2008-3 to the output mirror 2008-4. The β-BaB₂O₄ crystal 2008-6 produces laser beam of 252 nm wavelength as a result of sum frequency mixing as mentioned hereinafter.

The input coupling mirror 2008-1 to which multilayer coating has been doubly applied is arranged in such that 2% of laser beam of 780 nm wavelength are transmitted, 0.02% of laser beam of 373 nm wavelength is transmitted, 98% of laser beam of 780 nm wavelength are reflected, and 99.8% of laser beam of 373 nm wavelength are reflected. Moreover, the input coupling mirror 2008-2 to which multilayer coating has been doubly applied is arranged in such that 2% of laser beam of 373 nm wavelength are transmitted, 0.02% of laser beam of 780 nm wavelength is transmitted, 98% of laser beam of 373 nm wavelength are reflected, and 99.8% of laser beam of 780 nm wavelength are reflected. Further, the total reflection mirror 2008-3 is arranged in such that laser beam of 746 nm wavelength is not transmitted, laser beam of 373 nm is not transmitted, 99.9% or more of laser beam of 746 nm are reflected, and 99.9% of laser beam of 373 nm wavelength are reflected. Besides, the output mirror 2008-4 to which multilayer coating has been applied triply is arranged in such that 84% of laser beam of 252 nm wavelength are transmitted, while it exhibits 99.98% or more of reflectivity with respect to laser beam of 373 nm wavelength and laser beam of 780 nm wavelength.

The above-described four mirrors (the input coupling mirror 2008-1, the input coupling mirror 2008-2, the total reflection mirror 2008-3, and the output mirror 2008-4) are disposed so as to make such an optical path that laser beam of 746 nm wavelength that was output from the mode matching lens 2006 transmits the input coupling mirror 2008-1 to which the laser beam was input, proceeds to the input coupling mirror 2008-2, from which proceeds to the total reflection mirror 2008-3, from which passes through the β-BaB₂O₄ crystal 2008-6 to proceed to the output mirror 2008-4, and from which proceeds to the input coupling mirror 2008-1. Besides, these four mirrors are disposed so as to make an optical path wherein laser beam of 373 nm wavelength output from the first stage external resonator type wavelength conversion system 1000 transmits the input coupling mirror 2008-2 to which the laser beam was input, proceeds to the total reflection mirror 2008-3, from which passes through the β-BaB₂O₄ crystal 2008-6 to proceed to the output mirror 2008-4, from which proceeds to the input coupling mirror 1008-1, and from which proceeds to the input coupling mirror 2008-2.

Accordingly, an optical path of laser beam in a region surrounded by the input coupling mirror 2008-1, the input coupling mirror 2008-2, the total reflection mirror 2008-3, and the output mirror 2008-4 exhibits a bow-tie shape.

Eighty-four (84)% of transmitted laser beam of 252 nm wavelength among the laser beams, which proceeded to the total reflection mirror 2008-3, transmit to proceed to the high reflection mirror (HR252) 2010. Further, two(2)% of transmitted laser beam of 746 nm wavelength among the laser beams, which proceeded to the input coupling mirror 2008-1 from the output mirror 2008-4, proceed to the error signal generator 2012, and two (2)% of transmitted laser beam of 373 nm wavelength among the laser beams, which proceeded to the input coupling mirror 2008-2 from the input coupling mirror 2008-1, proceed to the error signal generator 2016.

In the following, an outline of operations in the coherent light source 500 will be described. First, in the first stage external resonator type wavelength conversion system 1000, laser beam of 746 nm wavelength output from the ring type single mode titanium sapphire laser 1002 is introduced into the resonator main body 1008, light intensity thereof is increased in the resonator main body 1008, whereby second harmonics (373 nm wavelength) are generated efficiently by means of the LiB₃O₅ crystal 2008-6 in the resonator main body 1008.

Succeedingly, in the second stage external resonator type wavelength conversion system 2000, laser beam having 373 nm wavelength of second harmonics obtained by the first stage external resonator type wavelength conversion system 1000 and a laser beam having 780 nm wavelength of the single mode semiconductor laser 2002 are introduced to the resonator main body 2008, a resonator length is fixed while maintaining resonance of the laser beam of 373 nm wavelength, and a frequency of the laser beam of 780 nm wavelength is adjusted minutely to stabilize the same, whereby both the wavelengths are doubly resonated. As a result of the simultaneous resonance of two wavelengths, the respective light intensities are increased at the same time, so that laser beam of 252 nm wavelength is generated at high efficiency as a result of sum frequency mixing by means of the β-BaB₂O₄ crystal 2008-6 in the resonator main body 2008.

In the following, details of generation of second harmonics in the first stage external resonator type wavelength conversion system 1000 will be described.

In the first stage external resonator type wavelength conversion system 1000, laser beam of 746 nm wavelength output from the ring type single mode CW titanium sapphire laser 1002 is introduced to the resonator main body 1008 provided with an bow-tie shaped optical path through the mode matching lens 1006. The resonator main body 1008 utilizes polarized light to increase interior light intensity while feeding back an error signal to the piezo element 1008-5 mounted additionally to the total reflection mirror 1008-2.

As described above, the LiB₃O₅ crystal 1008-6, which has been used as a nonlinear optical crystal, has an excision angle of “θ=90°” and “φ=37.5°”, a crystal length of 15 mm, and on an input side thereof antireflection coating of 746 nm wavelength has been applied, while on an output side thereof antireflection coating of 746 nm wavelength as well as antireflection coating of 373 nm wavelength have been applied.

Furthermore, since a loss in one round in an optical path of the external resonator main body 1088 may be estimated as 2%, optical impedance matching is intended with 98% reflectivity of the input coupling mirror 1008-1.

The output mirror 1008-4 to which multilayer coating has been doubly applied is arranged in such that, as described above, 95% of laser beam of 373 nm wavelength are transmitted, and 99.9% of laser beam of 746 nm wavelength are reflected. Each focal length of the total reflection mirror 1008-3 and the output mirror 1008-4 is 100 mm, and one round length in an optical path of the resonator main body is set to 650 mm.

A layout of four mirrors (the input coupling mirror 1008-1, the total reflection mirror 1008-2, the total reflection mirror 1008-3, and the output mirror 1008-4) and the LiB₃O₅ crystal 2008-6 is established so as to coincide a mode of the resonator main body 1008 with a mode of input beam, and to be the optimum value of 35 μm that was calculated in such that a beam waist size at the central part of the LiB₃0₅ crystal 2008-6 became optimum. In the optimum condition, a conversion efficiency of single optical path becomes “9.1×10⁻⁵W⁻¹”. The second harmonics output from the external resonator 1008 is paralleled independently in vertical and horizontal directions thereof by means of two condenser lenses 1010 and 1012 in order to compensate a divergence angle different vertically and horizontally that is produced by walk off effect in nonlinear crystal.

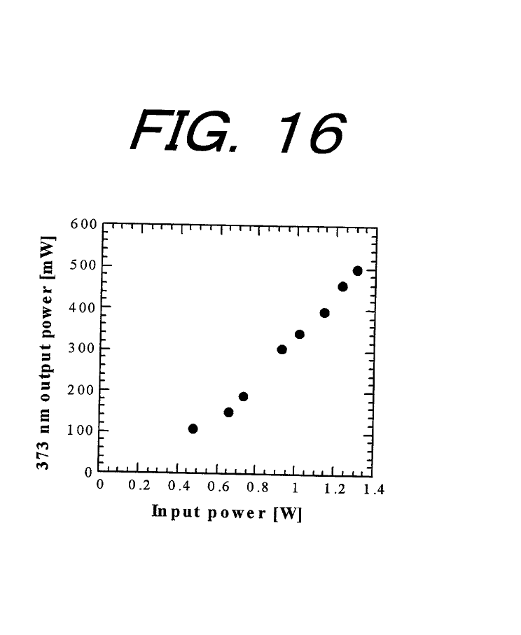

FIG. 16 indicates input fundamental wave dependency of a measured output of second harmonics wherein the maximum output of second harmonics was 500 mW. This result means that there was an output of 520 mW or higher immediately after the LiB₃O₅ crystal 2008-6 with taking transmission factors of the LiB₃O₅ crystal 2008-6 and the output mirror 1008-4 into consideration. In this case, conversion efficiency from an input fundamental wave to an output of second harmonics is even 40% or more.

An enhancement factor measured was 72 and this result means that a conversion efficiency of a single optical path comes to be “5.9×10⁻⁵W⁻¹” being 65% of the optimum value. As a cause for the result, it may be point out that there is a discrepancy of beam waist due to misalignment or the like. A loss for one round including the one due to incomplete coating may be estimated to be 1%. When a reflectivity of the input coupling mirror 1008-1 is optimized, elevation of optical impedance matching can be intended.

Next, details of generation of sum frequency in the second stage external resonator type wavelength conversion system 2000 will be described.

The resonator main body 2008 in the second stage external resonator type wavelength conversion system 2000 shown in the lower part of FIG. 15 is provided with an bow-tie shaped optical path as in the resonator main body 1008 in the first stage external resonator type wavelength conversion system 1000, and it involves the input coupling mirror 2008-1 for laser beam of 780 nm wavelength output from the taper type amplifier semiconductor laser 2002, and the input coupling mirror 2008-2 for second harmonics (373 nm wavelength)obtained by the resonator main body 1008 in the first stage external resonator type wavelength conversion system 1000.

As described above, each of these two input coupling mirrors has a reflection coefficient of 98% at their respective wavelengths, while each of them has a reflection coefficient of 99.8% or more at the other respective wavelengths. Moreover, multilayer coating has been applied triply to the output mirror 2008-4 wherein 84% of light having 252 nm wavelength are transmitted the mirror, but it exhibits 99.8% or higher reflectivity with respect to light having 373 nm wavelength and light of 780 nm wavelength.

A concave mirror having 50 mm curvature is used for each of the total reflection mirror 2008-3 and the output mirror 2008-4, and a resonator length is set to about 300 mm corresponding to about half of that of the resonator main body 1008 in the first stage external resonator type wavelength conversion system 1000.

Moreover, 17.1° cut β-BaB₂O₄ crystal 2008-6 having 10 mm length is used as a nonlinear crystal of the second stage external resonator type wavelength conversion system 2000. Anti-reflection coating has been applied to both end surfaces of the β-BaB₂O₄ crystal 2008-6 with respect to two types of input light (laser beam of 780 nm wavelength and second harmonics (laser beam of 373 nm wavelength)), and particularly, a further coating has been applied to the output side so as to obtain 95% transmission with respect to light having 252 nm wavelength.

In the resonator main body 2008 of the second stage external resonator type wavelength conversion system 2000, a feedback loop for resonating two types of light having a different frequency is formed.

Namely, a resonator length is controlled so as to resonate light having 373 nm wavelength by the use of the piezo element mounted on the total reflection mirror 2008-3 in accordance with the first feedback loop. More specifically, a feedback is applied after the resonator length was fixed in such that an oscillation frequency of the single mode semiconductor laser 2002 coincides with a resonator frequency that has been just stabilized, whereby simultaneous resonance of the laser beam of 373 nm wavelength and the laser beam of 780 nm wavelength was realized in the same resonator.

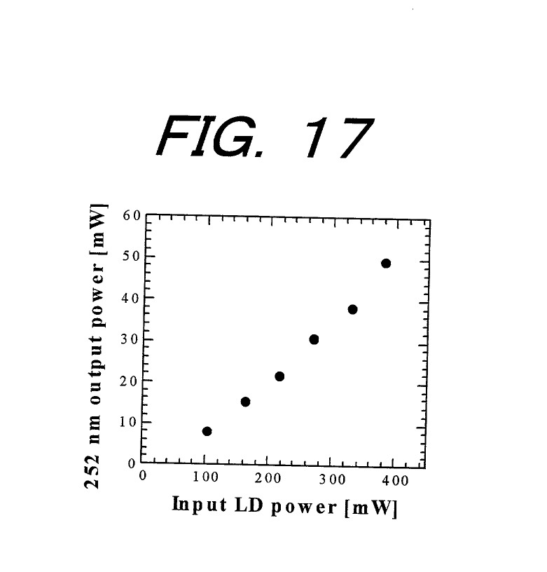

In FIG. 17, input power of laser beam of 780 nm wavelength is plotted as abscissa, and a measured value of output in laser beam of 252 nm wavelength taken out from the resonator main body 2008 as ordinate. In the case when laser beam of 373 nm is 480 mW and laser beam of 780 nm wavelength is 380 mW, 50 mW laser beam of 252 nm wavelength could be taken out form the resonator main body 2008. Judging from transmittances of the output mirror 2008-4 and the β-BaB₂O₄ crystal 2008-6, laser beam of 252 nm wavelength generated has a value exceeding 60 mW, and a conversion efficiency of sum frequency is estimated to be 7%. An enhancement factor was 92 with respect to laser beam of 780 nm wavelength, while it was 34 with respect to laser beam of 373 nm wavelength, and a loss in the whole resonators was 0.6% with respect to the laser beam of 780 nm, while it was 2.5% with respect to the laser beam of 373 nm. Taking these losses into consideration, a finesse of resonator may be calculated as 241 with respect to the laser beam of 780 nm wavelength, while as 141 with respect to the laser beam of 373 nm wavelength.

When a linewidth is determined from a relationship between free spectrum zone and finesse, it could be estimated to be 4.1 MHz with respect to the laser beam of 780 nm wavelength, while 7.1 MHz with respect to the light beam of 373 nm wavelength. From the above-described results, a linewidth in laser beam of 252 nm is estimated to be 12 MHz at the most, whereby it is found that the above value of linewidth is within 29 MHz natural width in laser cooling transition of silicon atoms.

Furthermore, when a wavelength of laser beam output from the single mode semiconductor laser 2002 changes from 780 nm to 785 nm and the optimum crystal angle is adjusted, tuning could be made within a wavelength range from 251 nm wavelength to 253 nm wavelength without accompanying decrease in output of substantially 50 mW. A wide tuning range can make possible to control easily silicon isotopes.

While the above-described embodiments of the present invention have been explained principally for cooling silicon atoms, the present invention is also applicable for atoms other than those of silicon, as a matter of course.

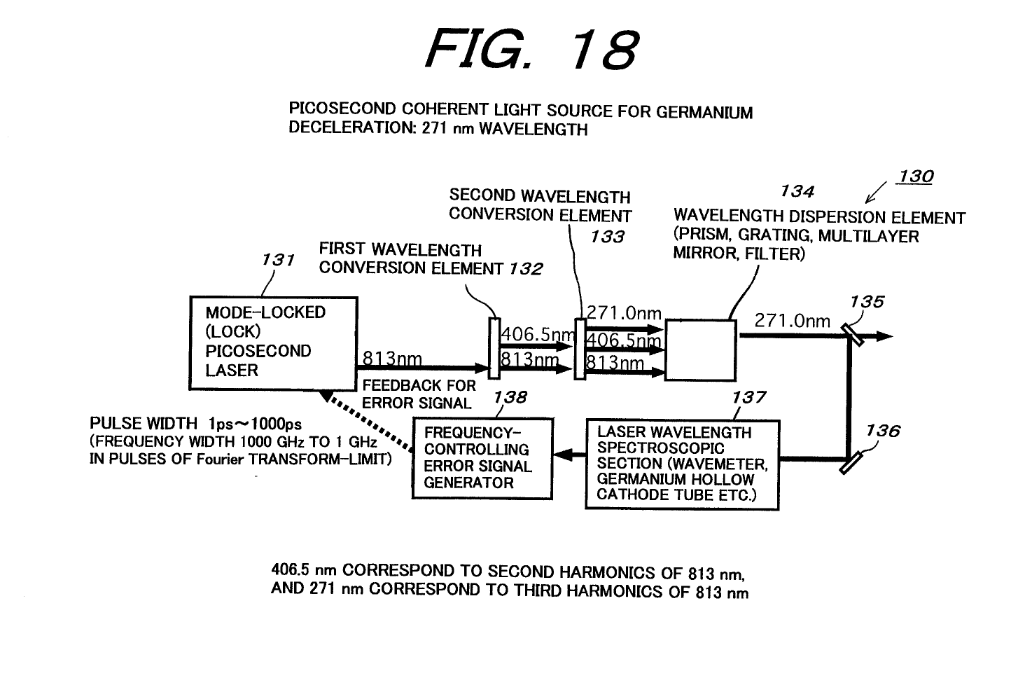

In the following, an example of the invention wherein a method, an apparatus, and a coherent light source according to the present invention are applied to germanium atoms will be described. First, an example of a preferred embodiment of a coherent light source used for laser cooling of germanium atoms will be described by referring to FIG. 18.

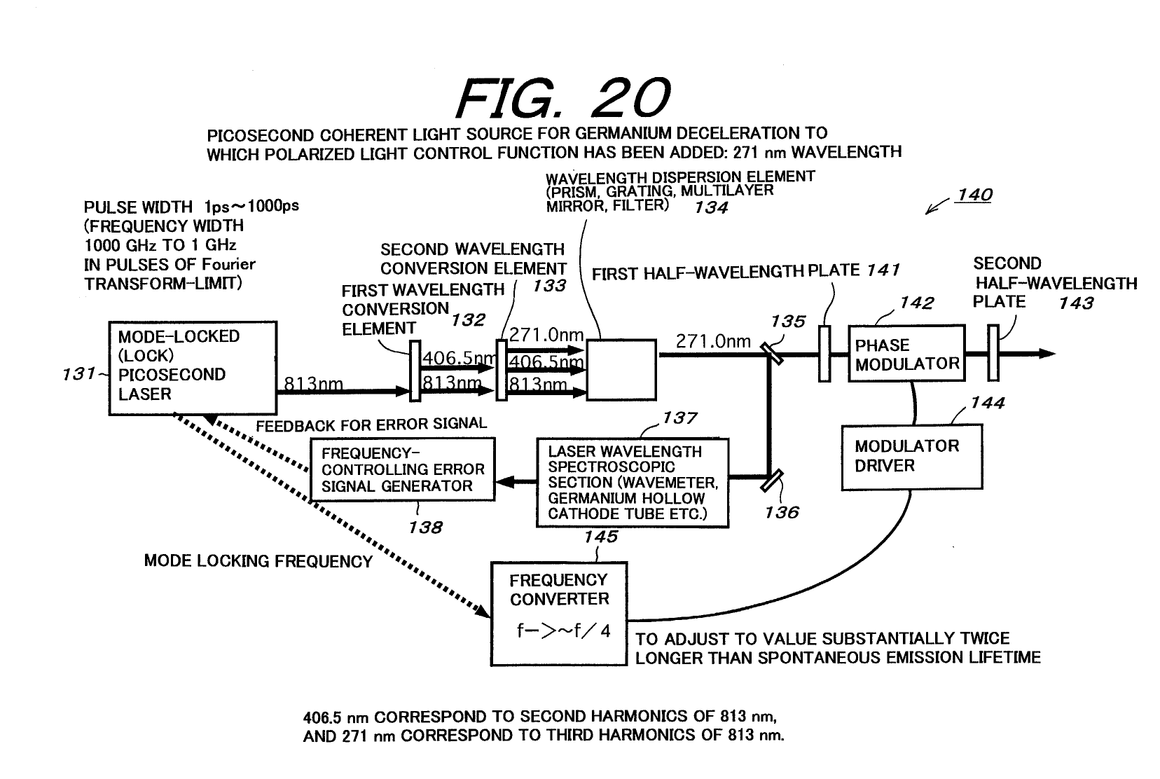

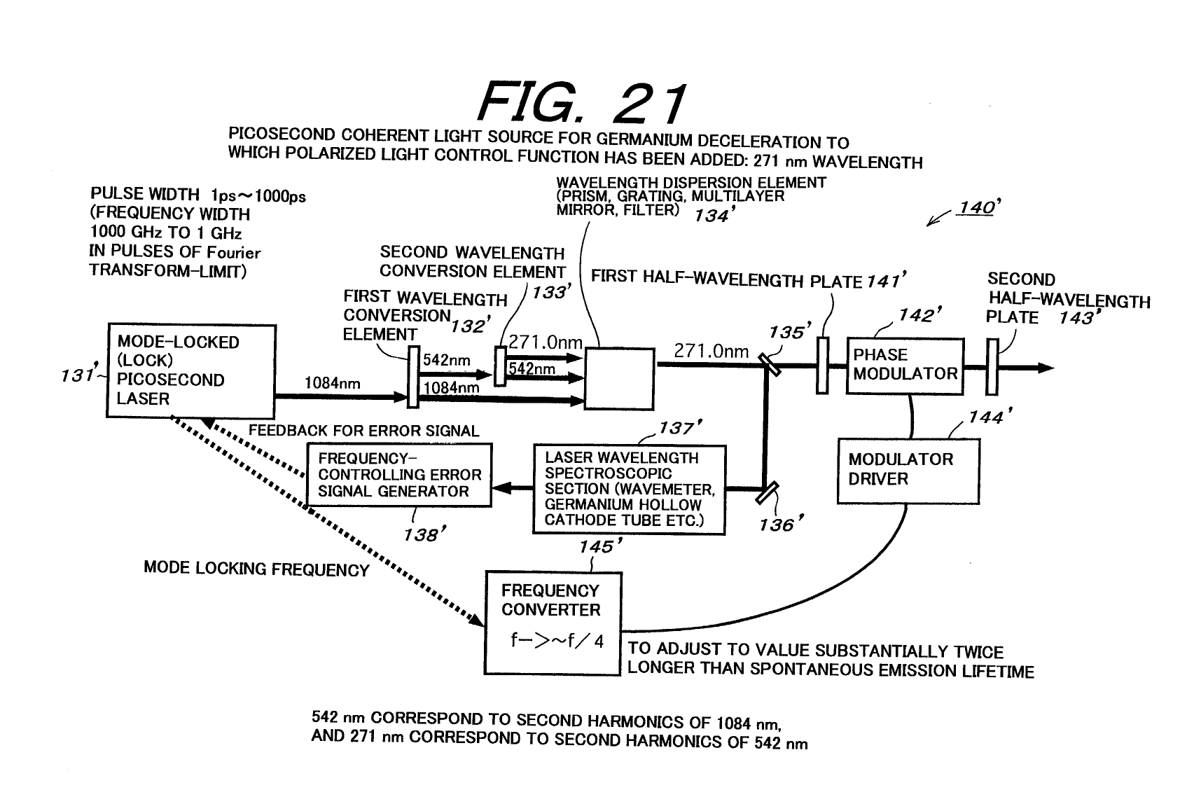

An example of the preferred embodiment of a coherent light source used for laser cooling of germanium atoms shown in FIG. 18 is a light source for decelerating germanium atoms by means of scattering force (hereinafter referred to as “picosecond coherent light source used for germanium deceleration”, and it may be used, for example, as the coherent light source section 52 in the laser cooling apparatus 50 of the present invention shown in FIG. 5; the first coherent light source section, the second coherent light source section, or the third coherent light source section in the laser cooling apparatus 80 according to the invention shown in FIG. 8(a); and the first coherent light source section or the second coherent light source section shown in FIG. 9(a), as a matter of course. Besides, the above-described light source may be used as a coherent light source in a laser cooling apparatus according to the present invention shown in FIG. 20, which will be described later.

A picosecond coherent light source used for germanium deceleration 130 shown in FIG. 18 is constituted so as to be capable of emitting coherent light of 271.0 nm wavelength, which includes a mode-locked (lock) picosecond laser 131, a first wavelength conversion element 132, a second wavelength conversion element 133, a wavelength dispersion element 134, a partial reflection mirror 135, a total reflection mirror 136, a laser wavelength spectroscopic section 137, and a frequency-controlling error signal generator 138. Further, a feedback loop for inputting an error signal to the mode-locked (lock) picosecond laser 131 as a feedback signal is composed of the partial reflection mirror 135, the total reflection mirror 136, the laser wavelength spectroscopic section 137, and the frequency-controlling error signal generator 138.

In this case, the mode-locked (lock) picosecond laser 131 outputs coherent light having a pulse width of from 1 ps to 1000 ps at 813 nm wavelength (a frequency zone of from 1000 GHz to 1 GHz in Fourier transform-limited pulse).

First, coherent light of 813 nm wavelength output from the mode-locked (lock) picosecond laser 131 is input to the first wavelength conversion element 132, so that coherent light of 813 nm wavelength and coherent light being its second harmonics of 406.5 nm wavelength are obtained by means of the first wavelength conversion element 132.

Then, coherent light of 813 nm wavelength and coherent light of 406.5 nm wavelength output from the first wavelength conversion element 132 are input to the second wavelength conversion element 133, so that coherent light of 813 nm wavelength, coherent light being its second harmonics of 406.5 nm wavelength, and coherent light being its third harmonics of 271.0 nm wavelength are obtained by means of the second wavelength conversion element 133.

Moreover, when coherent light of 813 nm wavelength, coherent light of 406.5 nm wavelength, and coherent light of 271.0 nm wavelength output from the second wavelength conversion element 133 are input to the wavelength dispersion element 134, only coherent light of 271.0 nm wavelength is output from the wavelength dispersion element 134 to transmit the partial reflection mirror 135, and the resulting light is used for deceleration of germanium atoms by means of scattering force. In this case, the wavelength dispersion element 134 is prepared from, for example, prism, grating, multilayer mirror, filter or the like.

On one hand, coherent light having 271.0 nm wavelength reflected by the partial reflection mirror 135 is reflected by the total reflection mirror 136 to be input to the laser wavelength spectroscopic section 137 composed of a wavemeter, a silicon hollow cathode tube and the like.

A wavelength of the coherent light thus input is measured by the laser wavelength spectroscopic section 137, and the measured result is input to the frequency-controlling error signal generator 138.

The frequency-controlling error signal generator 138 feedbacks an error signal on the basis of the measured result input in such that the mode-locked (lock) picosecond laser 131 produces always coherent light having 813 nm wavelength.

As a result of such feedback control, it becomes possible to emit always coherent light of 271.0 nm wavelength to germanium atoms.

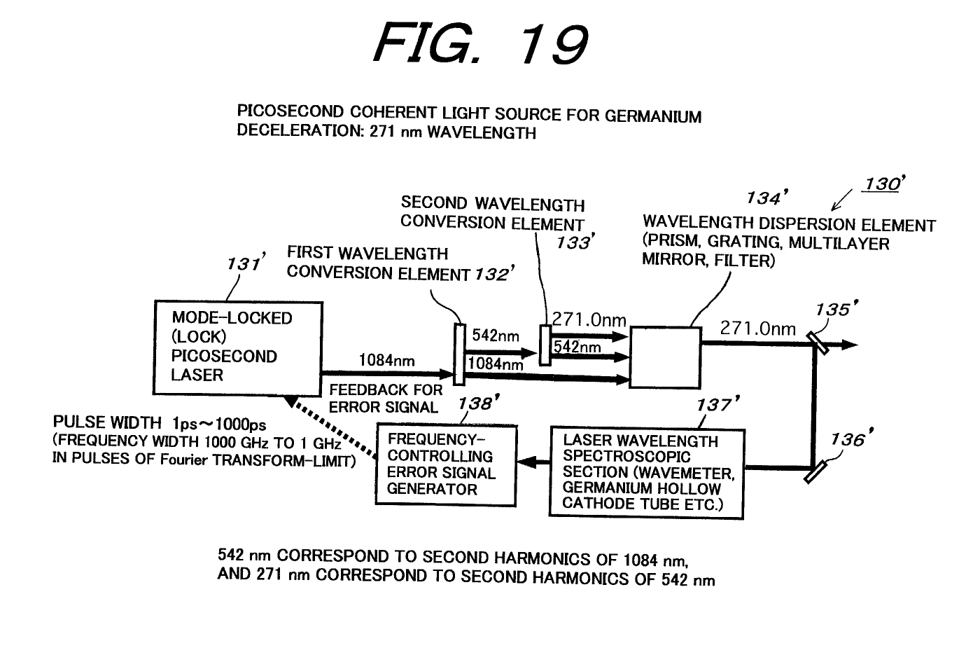

FIG. 19 shows an example of another preferred embodiment of the picosecond coherent light source used for germanium deceleration 130 shown in FIG. 18 wherein the same or equivalent components as or to those of FIG. 18 are designated by such numerals each obtained by adding a sign “‘” to a corresponding reference numeral in FIG. 18, and the detailed description therefor will be omitted.

A picosecond coherent light source used for germanium deceleration 130′ shown in FIG. 19 is constituted so as to be capable of emitting coherent light having 271.0 nm wavelength, which includes a mode-locked (lock) picosecond laser 131′, a first wavelength conversion element 132′, a second wavelength conversion element 133′, a wavelength dispersion element 134′, a partial reflection mirror 135′, a total reflection mirror 136′, a laser wavelength spectroscopic section 137′, and a frequency-controlling error signal generator 138′. Further, a feedback loop for inputting an error signal to the mode-locked (lock) picosecond laser 131′ as a feedback signal is composed of the partial reflection mirror 135′, the total reflection mirror 136′, the laser wavelength spectroscopic section 137′, and the frequency-controlling error signal generator 138′.

In this case, the mode-locked (lock) picosecond laser 131′ outputs coherent light having a pulse width of from 1 ps to 1000 ps at 1084 nm wavelength (a frequency zone of from 1000 GHz to 1 GHz in Fourier transform-limited pulse).

First, coherent light of 1084 nm wavelength output from the mode-locked (lock) picosecond laser 131′ is input to the first wavelength conversion element 132′, so that coherent light of 1084 nm wavelength and coherent light being its second harmonics of 542 nm wavelength are obtained by means of the first wavelength conversion element 132′.

Then, coherent light of 542 nm wavelength output from the first wavelength conversion element 132′ is input to the second wavelength conversion element 103′, so that coherent light of 542 nm wavelength, and coherent light being its second harmonics of 271.0 nm wavelength are obtained by means of the second wavelength conversion element 133′.

Moreover, when coherent light of 542 nm wavelength and coherent light of 271.0 nm wavelength output from the second wavelength conversion element 133′ as well as coherent light of 1084 nm wavelength output from the first wavelength conversion element 132′ are input to the wavelength dispersion element 134′, only coherent light of 271.0 nm wavelength is output from the wavelength dispersion element 134′ to transmit the partial reflection mirror 135′, and the resulting light is used for deceleration of germanium atoms by means of scattering force. In this case, the wavelength dispersion element 134′ is prepared from, for example, prism, grating, multilayer mirror, filter or the like.

On one hand, coherent light having 271.0 nm wavelength reflected by the partial reflection mirror 135′ is reflected by the total reflection mirror 136′ to be input to the laser wavelength spectroscopic section 137′ composed of a wavemeter, a silicon hollow cathode tube and the like.

A wavelength of the coherent light thus input is measured by the laser wavelength spectroscopic section 137′, and the measured result is input to the frequency-controlling error signal generator 138′.

The frequency-controlling error signal generator 138′ feedbacks an error signal on the basis of the measured result input in such that the mode-locked (lock) picosecond laser 131′ produces always coherent light having 1084 nm wavelength.

As a result of such feedback control, it becomes possible to emit always coherent light of 271.0 nm wavelength to germanium atoms.

In the following, an example of a preferred embodiment of a laser cooling apparatus according to the present invention wherein one picosecond coherent light source used for germanium deceleration 130 shown in FIG. 18 is used as a coherent light source used for laser cooling of atoms (a picosecond coherent light source used for germanium deceleration to which polarized light control function has been added) will be described by referring to FIG. 20 wherein the same or equivalent components as or to those of FIG. 18 are designated by the same reference numerals those used in FIG. 18, and the detailed description therefor will be omitted.

On a laser cooling apparatus 140 according to the present invention, a first half-wavelength plate 141, a phase modulator 142, a second half -wavelength plate 143, a modulator driver 144, and a frequency converter 145 are mounted as a polarized light control section.

The frequency converter 145 outputs a control signal to the modulator driver 144 in such that a modulating signal is output to the phase modulator 142 from the modulator driver 144 in a substantially twice longer period of spontaneous emission lifetime of germanium atom, when a mode locking frequency is input to the frequency converter 145 and the mode locking frequency is subjected to frequency conversion. In other words, polarized light of coherent light output from the phase modulator 142 is set to be switched in a period substantially twice longer than spontaneous emission lifetime of germanium atom.

More specifically, coherent light of 271.0 nm wavelength is controlled by the polarized light control section so as to be switched in a frequency substantially twice longer than the spontaneous emission lifetime of germanium atom.

In the following, an example of another preferred embodiment of a laser cooling apparatus according to the present invention shown in FIG. 20 wherein one picosecond coherent light source used for germanium deceleration 130′ shown in FIG. 19 is used as a coherent light source used for laser cooling of atoms (a picosecond coherent light source used for germanium deceleration to which polarized light control function has been added) will be described by referring to FIG. 21 wherein the same or equivalent components as or to those of FIG. 19 are designated by the same reference numerals those used in FIG. 19, besides, the same or equivalent components as or to those of FIG. 20 are designated by such numerals each obtained by adding a sign “‘” to a corresponding reference numeral in FIG. 20, and the detailed description for these components will be omitted.

On a laser cooling apparatus 140′ according to the present invention, a first half-wavelength plate 141′, a phase modulator 142′, a second half-wavelength plate 143′, a modulator driver 144′, and a frequency converter 145′ are mounted as a polarized light control section.

The frequency converter 145′ outputs a control signal to the modulator driver 144′ in such that a modulating signal is output to the phase modulator 142′ from the modulator driver 144′ in a substantially twice longer period of spontaneous emission lifetime of germanium atom, when a mode locking frequency is input to the frequency converter 145′ and the mode locking frequency is subjected to frequency conversion. In other words, polarized light of coherent light output from the phase modulator 112′ is set to be switched in a period substantially twice longer than spontaneous emission lifetime of germanium atom.

More specifically, coherent light of 271.0 nm wavelength is controlled by the polarized light control section so as to be switched in a frequency substantially twice longer than the spontaneous emission lifetime of germanium atom.

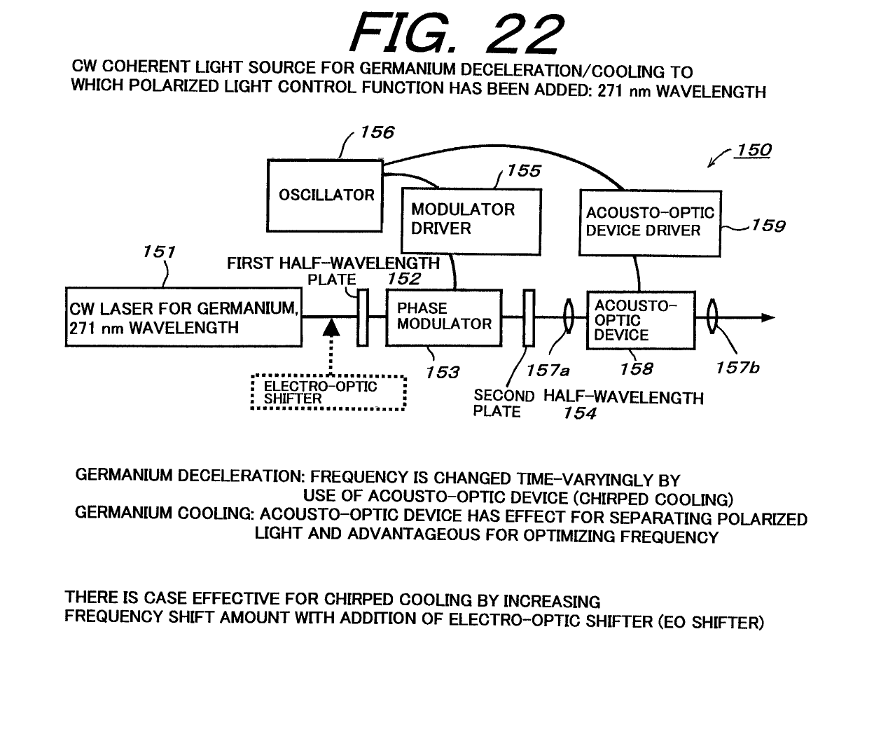

Next, an example of a preferred embodiment of a laser cooling apparatus wherein a CW laser is used as a coherent light source utilized for laser cooling of atoms producing coherent light having a predetermined wavelength (a CW coherent light source used for germanium deceleration/cooling to which polarized light control function has been added) will be described by referring to FIG. 22.

In a laser cooling apparatus 150 according to the present invention shown in FIG. 22, one CW laser of 271 nm wavelength is specifically employed as the above-described CW laser.

The laser cooling apparatus 150 of the present invention can function to effect both deceleration by means of scattering force and cooling by means of scattering force with respect to germanium atoms.

Namely, the laser cooling apparatus 150 of the invention is provided with a CW laser 151 of 271 nm wavelength for germanium use as a coherent light source used for laser cooling of atoms, and a polarized light control section including a first half-wavelength plate 152, a phase modulator 153, a second half-wavelength plate 154, a modulator driver 155, an oscillator 156, a first lens 157a, an acousto-optic device 158, a second lens 157b, and an acousto-optic device driver 159.

In the case where germanium atoms are decelerated by scattering force, a frequency is changed time-varyingly by the use of the acousto-optic device 158 to implement chirped cooling.

On one hand, in the case where germanium atoms are cooled by scattering force, the acousto-optic device 158 has an effect for separating time-varyingly polarized light and is convenient for optimizing a frequency.

There is a case that is effective for chirped cooling to install additionally an electro-optic shifter (EO shifter) between the CW laser for germanium use 151 and the first half-wavelength plate 152 to increase a frequency shift amount. Accordingly, such electro-optic shifter may optionally be disposed in the above-described position.

As the CW laser for germanium use 151 of 271 nm wavelength, for example, a fiber laser or fourth harmonics of a semiconductor laser of 1084 nm may be used, or second harmonics of a semiconductor laser of 542 nm wavelength or a semiconductor laser of 271 nm wavelength may be used.

While silicon atoms and germanium atoms have been described as objects to be cooled in the above-described embodiments, the invention is not limited thereto as a matter of course, but atoms of various elements can be processed as those being objects to be cooled in accordance with the present invention.

More specifically, when a coherent light having a wavelength that is coincident with an atomic resonance line of wavelengths, or that is positively or negatively detuned wavelengths of a desired one among predetermined types of atoms constituting atoms to be handled, for example, various isotopes, is emitted to the atomic beam in question from a coherent light source device, the same functions and advantageous effects as those of the above-described embodiments can be obtained.

Since the present invention has been constituted as described above, there is an excellent advantage to provide a method for laser cooling of atoms in accordance with polarized light control by which laser cooling of a variety of atoms including semiconductor atoms such as silicon and germanium becomes possible, an apparatus therefor as well as a light source device used therein.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2001-20243 filed on Jan. 29, 2001 and Japanese Patent Application No. 2002-11558 filed on Jan. 21, 2002 including specification, claims, drawing and summary are incorporated herein by reference in its entirety.

What is claimed is:

1. A method for laser cooling of atoms for laser-cooling atoms each involving a plurality of magnetic subsidiary levels as its cooling lower level being in a ground state in energy level, comprising:
emitting sequentially each coherent light of a predetermined wavelength containing a plurality of different polarized light to the atoms in response to the plurality of magnetic subsidiary levels being the cooling lower level in the ground state in an atom, which is an object to be laser-cooled, while keeping a predetermined time interval.

2. A method for laser cooling of atoms as claimed in claim 1 wherein said predetermined time interval is that substantially twice longer than spontaneous emission lifetime of the atom corresponding to a time required for absorption—emission of one photon.

3. An apparatus for laser cooling of atoms for laser-cooling atoms each involving a plurality of magnetic subsidiary levels as its cooling lower level being in a ground state in energy level, comprising:
a coherent light source for producing a coherent light having a predetermined wavelength;
a polarized light control means for controlling polarized light of the coherent light output from said coherent light source to emit the coherent light of different polarized light to the atom with a predetermined time interval; and
the polarized light of the coherent light emitted from said polarized light control means corresponds respectively to the plurality of different polarized light in response to the plurality of magnetic subsidiary levels being the cooling lower level in the ground state of an atom, which is an object to be laser-cooled.

4. An apparatus for laser cooling of atoms for laser-cooling atoms each involving a plurality of magnetic subsidiary levels as its cooling lower level being in a ground state in energy level, comprising:
a plurality of coherent light sources outputting respectively a coherent light of a predetermined wavelength involving respectively a plurality of different polarized light in response to the plurality of magnetic subsidiary levels being the cooling level in the ground state of an atom, which is an object to be cooled;
each coherent light of the predetermined wavelength containing the plurality of different polarized light output from said plurality of coherent light sources being sequentially emitted to the atom while keeping a predetermined time interval; and
the polarized light of the coherent light emitted from said plurality of coherent light sources corresponding respectively to the plurality of different polarized light in response to the plurality of magnetic subsidiary levels being the cooling lower level in the ground state of the atom, which is the object to be laser-cooled.

5. An apparatus for laser cooling of atoms as claimed in claim 4 wherein:
at least one of said plurality of coherent light sources is that outputs selectively coherent light involving two different polarized light.

6. An apparatus for laser cooling of atoms as claimed in claim 3 wherein:
said predetermined time interval is that substantially twice longer than spontaneous emission lifetime of the atom corresponding to a time required for absorption—emission of one photon.

7. An apparatus for laser cooling of atoms as claimed in claim 4 wherein:
said predetermined time interval is that substantially twice longer than spontaneous emission lifetime of the atom corresponding to a time required for absorption—emission of one photon.

8. An apparatus for laser cooling of atoms as claimed in claim 5 wherein:
said predetermined time interval is that substantially twice longer than spontaneous emission lifetime of the atom corresponding to a time required for absorption—emission of one photon.

9. A coherent light source used for laser cooling of atoms, comprising:
a mode-locked (lock) picosecond laser for outputting coherent light of a predetermined wavelength;
a wavelength conversion element for converting a wavelength of the coherent light of the predetermined wavelength output from said mode-locked (lock) picosecond laser;
a wavelength dispersion element for selecting coherent light of a desired wavelength from the coherent light, which has been subjected to wavelength conversion by means of said wavelength conversion element, to output said coherent light selected; and
a feedback circuit for measuring a wavelength of the coherent light output from said wavelength dispersion element to output a signal to said mode-locked (lock) picosecond laser in such that said mode-locked (lock) picosecond laser outputs coherent light of a predetermined wavelength on the basis of the measured result.

10. An apparatus for laser cooling of atoms for laser-cooling atoms each involving a plurality of magnetic subsidiary levels as its cooling lower level being in a ground state in energy level, comprising:
a coherent light source producing coherent light of predetermined wavelength;
a polarized light control means including a half-wavelength plate and an acousto-optic device, and controlling polarized light obtained from the coherent light output from said coherent light source by means of said half-wavelength plate to emit coherent light involving different polarized light to the atoms with a predetermined time interval; and
chirped cooling being effected by changing time-varyingly a frequency by the use of said acousto-optic device to decelerate the atoms as well as to separate time-varyingly the polarized light obtained by means of said half-wavelength plate with the use of said acousto-optic device, besides to optimize the frequency thereby cooling the atoms by means of scattering force.

11. A coherent light source used for laser cooling of atoms, comprising:
a first laser beam producing system for producing laser beam of a first wavelength; and
a second laser beam producing system for producing laser beam of a second wavelength as well as for introducing said laser beam of the first wavelength produced in said first laser beam producing system there into to produce laser beam of a third wavelength as a result of sum frequency mixing of the laser beam of said first wavelength and the laser beam of said second wavelength.

12. An apparatus for laser cooling of atoms for laser-cooling atoms each involving a plurality of magnetic subsidiary levels as its cooling lower level being in a ground state in energy level, comprising:
a coherent light source including a first laser beam producing system for producing laser beam of a first wavelength, and a second laser beam producing system for producing laser beam of a second wavelength as well as for introducing said laser beam of the first wavelength produced in said first laser beam producing system there into to produce laser beam of a third wavelength as a result of sum frequency mixing of the laser beam of said first wavelength and the laser beam of said second wavelength;
a polarized light control means including a half-wavelength plate and an acousto-optic device, and controlling polarized light obtained from the coherent light output from said coherent light source by means of said half-wavelength plate to emit coherent light involving different polarized light to the atoms with a predetermined time interval; and
chirped cooling being effected by changing time-varyingly a frequency by the use of said acousto-optic device to decelerate the atoms as well as to separate time-varyingly the polarized light obtained by means of said half-wavelength plate with the use of said acousto-optic device, besides to optimize the frequency thereby cooling the atoms by means of scattering force.
